(19) United States
(12) Patent Application Publication
(10) Pub. No.: US 2022/0129675 A1
(43) Pub. Date: Apr. 28, 2022

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Masafumi Takimoto, Kanagawa (JP); Tatsuya Yamamoto, Tokyo (JP); Eita Ono, Tokyo (JP); Satoru Mamiya, Kanagawa (JP); Shigeki Hirooka, Kanagawa (JP)

(21) Appl. No.: 17/509,444

(22) Filed: Oct. 25, 2021

(30) Foreign Application Priority Data
Oct. 27, 2020 (JP) 2020-179983
Jan. 5, 2021 (JP) 2021-000560
Jan. 6, 2021 (JP) 2021-000840

(51) Int. Cl. G06K 9/00; G06K 9/62; G06K 9/32; G06N 20/00

(52) U.S. Cl. CPC G06K 9/00657; G06K 9/6227; G06K 2209/21; G06N 20/00; G06K 9/3233

(57) ABSTRACT

An information processing apparatus comprises a first selection unit configured to select, as at least one candidate learning model, at least one learning model from a plurality of learning models learned under learning environments different from each other based on information concerning image capturing of an object, a second selection unit configured to select at least one candidate learning model from the at least one candidate learning model based on a result of object detection processing by the at least one candidate learning model selected by the first selection unit, and a detection unit configured to perform the object detection processing for a captured image of the object using at least one candidate learning model of the at least one candidate learning model selected by the second selection unit.

### BACKGROUND OF THE INVENTION

### Field of the Invention

The present invention relates to a technique for prediction based on a captured image.

### Description of the Related Art

In agriculture, recently, activities for solving problems by IT have vigorously been made to solve a variety of problems such as yield prediction, prediction of an optimum harvest time, control of an agrochemical spraying amount, and a farm field restoration plan.

For example, Japanese Patent Laid-Open No. 2005-137209 discloses a method of appropriately referring to sensor information acquired from a farm field to grow a crop and a database that stores these pieces of information, thereby early grasping a growth situation and harvest prediction and early finding an abnormal growth state and coping with this.

Japanese Patent Laid-Open No. 2016-49102 discloses a method of performing farm field management, in which pieces of registered information are referred to based on information acquired from a variety of sensors concerning a crop, and an arbitrary inference is made, thereby suppressing variations in the quality and yield of a crop.

However, the conventionally proposed methods assume that a sufficient number of cases acquired in the past for the farm field to execute prediction and the like are held, and an adjusting operation for accurately estimating prediction items based on information concerning the cases is completed.

On the other hand, in general, the yield of a crop is greatly affected by variations in the environment such as weather and climate, and also largely changes depending on the spraying state of a fertilizer/agrochemical, or the like by a worker. If the conditions by all external factors remain unchanged every year, yield prediction or prediction of a harvest time need not be executed at all. However, unlike industry, agriculture has many external factors that cannot be controlled by a worker himself/herself, and prediction is very difficult. In addition, when predicting a yield or the like in a case in which an unexperienced weather continues, it is difficult for the above-described estimation system adjusted based on cases acquired in the past to do correct prediction.

A case in which the prediction is most difficult is a case in which the above-described prediction system is newly introduced into a farm field. For example, consider a case in which yield prediction of a specific farm field is performed, or a nonproductive region is detected for the purpose of repairing a poor growth region (dead branches/lesions). In such a task, normally, images and parameters concerning a crop and collected in the farm field in the past are held in a database. When actually executing prediction and the like for the farm field, images captured in the observed current farm field and other data concerning growth information and acquired from sensors are referred to mutually and adjusted, thereby performing accurate prediction. However, as described above, if the prediction system or the nonproductive region detector is introduced into a new different farm field, conditions (of farm fields) do not match in many cases, and therefore, these cannot immediately be applied. In this case, it is necessary to perform an operation of collecting a sufficient number of data in the new farm field and adjusting these.

Also, when the adjustment of the above-described prediction system or nonproductive region detector is performed by manual adjustment, parameters concerning the growth of a crop are high-dimensional, and therefore, much labor is required. Additionally, even in a case in which adjustment is executed by deep learning or a machine learning method based on this, a manual label assignment (annotation) operation is normally needed to ensure high performance for a new input, and therefore, the operation cost is high.

Originally, even when the prediction system is newly introduced, or even in a case of a natural disaster or weather never seen before, satisfactory prediction/estimation is preferably done by simple settings with little load on a user.

### SUMMARY OF THE INVENTION

The present invention provides a technique for enabling processing by a learning model according to a situation even if processing is difficult based on only information collected in the past, or even if information collected in the past does not exist.

According to the first aspect of the present invention, there is provided an information processing apparatus comprising: a first selection unit configured to select, as at least one candidate learning model, at least one learning model from a plurality of learning models learned under learning environments different from each other based on information concerning image capturing of an object; a second selection unit configured to select at least one candidate learning model from the at least one candidate learning model based on a result of object detection processing by the at least one candidate learning model selected by the first selection unit; and a detection unit configured to perform the object detection processing for a captured image of the object using at least one candidate learning model of the at least one candidate learning model selected by the second selection unit.

According to the second aspect of the present invention, there is provided an information processing method performed by an information processing apparatus, comprising: selecting, as at least one candidate learning model, at least one learning model from a plurality of learning models learned under learning environments different from each other based on information concerning image capturing of an object; selecting at least one candidate learning model from the at least one candidate learning model based on a result of object detection processing by the selected at least one candidate learning model; and performing the object detection processing for a captured image of the object using at least one candidate learning model of the selected at least one candidate learning model.

According to the third aspect of the present invention, there is provided a non-transitory computer-readable storage medium storing a computer program configured to cause a computer to function as: a first selection unit configured to select, as at least one candidate learning model, at least one learning model from a plurality of learning models learned under learning environments different from each other based on information concerning image capturing of an object; a second selection unit configured to select at least one candidate learning model from the at least one candidate learning model based on a result of object detection processing by the at least one candidate learning model selected by the first selection unit; and a detection unit configured to perform the object detection processing for a captured image of the object using at least one candidate learning model of the at least one candidate learning model selected by the second selection unit.

Further features of the present invention will become apparent from the following description of exemplary embodiments with reference to the attached drawings.

### BRIEF DESCRIPTION OF THE DRAWINGS

FIG. 1 is a block diagram showing an example of the configuration of a system;

FIG. 2A is a flowchart of processing to be executed by the system;

FIG. 2B is a flowchart showing details of processing in step S23;

FIG. 2C is a flowchart showing details of processing in step S233;

FIG. 3A is a view showing an example of a farm field image capturing method by a camera 10;

FIG. 3B is a view showing an example of a farm field image capturing method by the camera 10;

FIG. 4A is a view showing a difficult case;

FIG. 4B is a view showing a difficult case;

FIG. 5A is a view showing a result of performing an annotation operation for a captured image;

FIG. 5B is a view showing a result of performing an annotation operation for a captured image;

FIG. 6A is a view showing a display example of a GUI;

FIG. 6B is a view showing a display example of a GUI;

FIG. 7A is a view showing a display example of a GUI;

FIG. 7B is a view showing a display example of a GUI;

FIG. 8A is a flowchart of processing to be executed by a system;

FIG. 8B is a flowchart showing details of processing in step S83;

FIG. 8C is a flowchart showing details of processing in step S833;

FIG. 9A is a view showing a detection example of a detection region;

FIG. 9B is a view showing a detection example of a detection region;

FIG. 10A is a view showing a display example of a GUI;

FIG. 10B is a view showing a display example of a GUI;

FIG. 11A is a view showing an example of the configuration of a query parameter;

FIG. 11B is a view showing an example of the configuration of a parameter set of a learning model;

FIG. 11C is a view showing an example of the configuration of a query parameter;

FIG. 12A is a flowchart of a series of processes of specifying a captured image that needs an annotation operation, accepting the annotation operation for the captured image, and performing additional learning of a learning model using the captured image that has undergone the annotation operation;

FIG. 12B is a flowchart showing details of processing in step S523;

FIG. 12C is a flowchart showing details of processing in step S5234;

FIG. 13A is a view showing a display example of a GUI;

FIG. 13B is a view showing a display example of a GUI;

FIG. 14A is a flowchart of setting processing of an inspection apparatus (setting processing for visual inspection);

FIG. 14B is a flowchart showing details of processing in step S583;

FIG. 14C is a flowchart showing details of processing in step S5833;

FIG. 15A is a view showing a display example of a GUI;

FIG. 15B is a view showing a display example of a GUI;

FIG. 16 is a Venn diagram;

FIG. 17 is an explanatory view for explaining the outline of an information processing system;

FIG. 18 is an explanatory view for explaining the outline of the information processing system;

FIG. 19 is a block diagram showing an example of the hardware configuration of an information processing apparatus;

FIG. 20 is a block diagram showing an example of the functional configuration of the information processing apparatus;

FIG. 21 is a view showing an example of a screen concerning model selection;

FIG. 22 is a view showing an example of a section management table;

FIG. 23 is a view showing an example of an image management table;

FIG. 24 is a view showing an example of a model management table;

FIG. 25 is a flowchart showing an example of processing of the information processing apparatus;

FIG. 26 is a flowchart showing an example of processing of the information processing apparatus;

FIG. 27 is a view showing an example of the correspondence relationship between an image capturing position and a boundary of sections;

FIG. 28 is a view showing another example of the model management table;

FIG. 29 is a flowchart showing another example of processing of the information processing apparatus;

FIG. 30 is a flowchart showing still another example of processing of the information processing apparatus;

FIG. 31 is a flowchart showing still another example of processing of the information processing apparatus;

FIG. 32 is a view showing another example of the image management table; and

FIG. 33 is a flowchart showing still another example of processing of the information processing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In this embodiment, a system that performs, based on images of a farm field captured by a camera, analysis processing such as prediction of a yield of a crop in the farm field and detection of a repair part will be described.

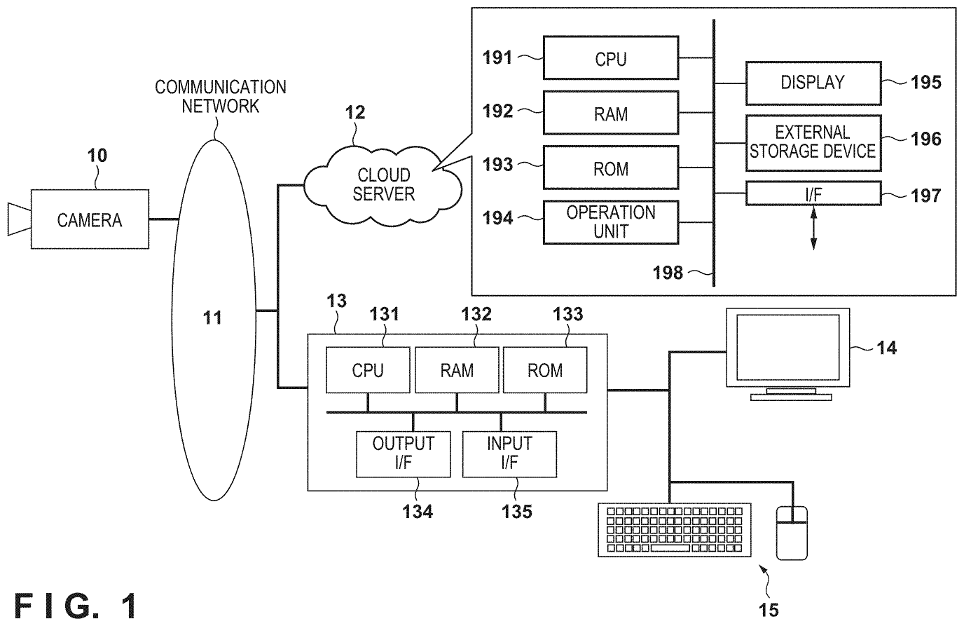

An example of the configuration of the system according to this embodiment will be described first with reference to FIG. 1. As shown in FIG. 1, the system according to this embodiment includes a camera 10, a cloud server 12, and an information processing apparatus 13.

The camera 10 will be described first. The camera 10 captures a moving image of a farm field and outputs the image of each frame of the moving image as “a captured image of the farm field”. Alternatively, the camera 10 periodically or non-periodically captures a still image of a farm field and outputs the captured still image as “a captured image of the farm field”. To correctly perform prediction to be described later from the captured image, images captured in the same farm field are preferably captured under the same environment and conditions as much as possible. The captured image output from the camera 10 is transmitted to the cloud server 12 or the information processing apparatus 13 via a communication network 11 such as a LAN or the Internet.

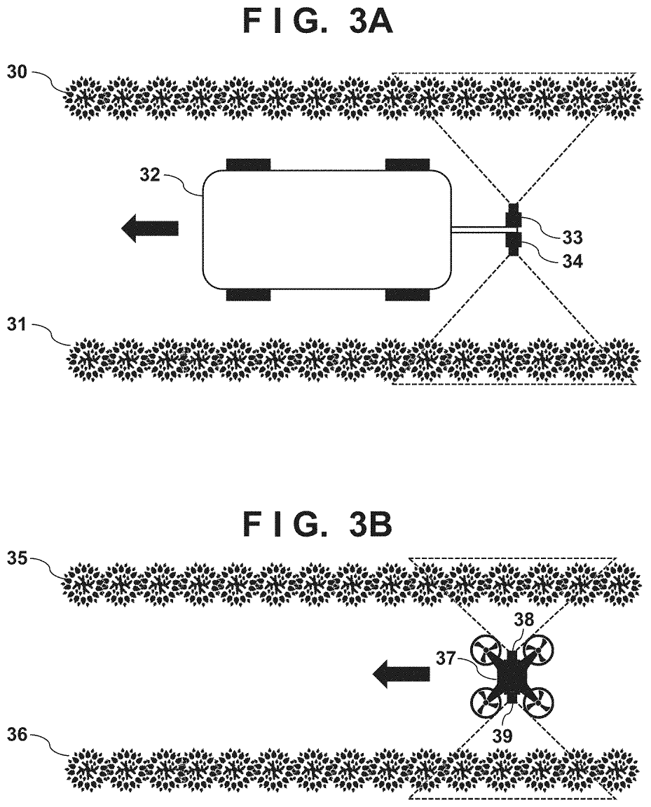

A farm field image capturing method by the camera 10 is not limited to a specific image capturing method. An example of the farm field image capturing method by the camera 10 will be described with reference to FIG. 3A. In FIG. 3A, a camera 33 and a camera 34 are used as the camera 10. In a general farm field, trees of a crop intentionally planted by a farmer form rows. For example, as shown in FIG. 3A, crop trees are planted in many rows, like a row 30 of crop trees and a row 31 of crop trees. A tractor 32 for agricultural work is provided with the camera 34 that captures the row 31 of crop trees on the left side in the advancing direction indicated by an arrow, and the camera 33 that captures the row 30 of crop trees on the right side. Hence, when the tractor 32 for agricultural work moves between the row 30 and the row 31 in the advancing direction indicated by the arrow, the camera 34 captures a plurality of images of the crop trees in the row 31, and the camera 33 captures a plurality of images of the crop trees in the row 30.

In many farm fields which are designed to allow the tractor 32 for agricultural work to enter for a work and in which crop trees are planted at equal intervals, crop trees are captured by the cameras 33 and 34 installed on the tractor 32 for agricultural work, as show in FIG. 3A, thereby relatively easily implementing capturing more crop trees at a predetermined height while maintaining a predetermined distance from the crop trees. For this reason, all images in the target farm field can be captured under almost the same conditions, and image capturing under desirable conditions is easily implemented.

Note that another image capturing method may be employed if it is possible to capture a farm field under almost the same conditions. An example of the farm field image capturing method by the camera 10 will be described with reference to FIG. 3B. In FIG. 3B, a camera 38 and camera 39 are used as the camera 10. As shown in FIG. 3B, in a farm field in which the interval between a row 35 of crop trees and a row 36 of crop trees is narrow, and traveling of a tractor is impossible, image capturing may be performed by the camera 38 and the camera 39 attached to a drone 37. The drone 37 is provided with the camera 39 that captures the row 36 of crop trees on the left side in the advancing direction indicated by an arrow, and the camera 38 that captures the row 35 of crop trees on the right side. Hence, when the drone 37 moves between the row 35 and the row 36 in the advancing direction indicated by the arrow, the camera 39 captures a plurality of images of the crop trees in the row 36, and the camera 38 captures a plurality of images of the crop trees in the row 35.

The images of the crop trees may be captured by a camera installed on a self-traveling robot. Also, the number of cameras used for image capturing is 2 in FIGS. 3A and 3B but is not limited to a specific number.

Regardless of what kind of image capturing method is used to capture the images of crop trees, the camera 10 attaches image capturing information at the time of capturing of the captured image (Exif information in which an image capturing position (for example, an image capturing position measured by GPS), an image capturing date/time, information concerning the camera 10, and the like are recorded) to each captured image and outputs it.

The cloud server 12 will be described next. Captured images and Exif information transmitted from the camera 10 are registered in the cloud server 12. Also, a plurality of learning models (detectors/settings) configured to detect an image region concerning a crop from a captured image are registered in the cloud server 12. The learning models are models learned under learning environments different from each other. The cloud server 12 selects, from the plurality of learning models held by itself, candidates for a learning model to be used to detect an image region concerning a crop from a captured image, and presents these on the information processing apparatus 13.

A CPU 191 executes various kinds of processing using computer programs and data stored in a RAM 192 or a ROM 193. Accordingly, the CPU 191 controls the operation of the entire cloud server 12, and executes or controls various kinds of processing to be explained as processing to be performed by the cloud server 12.

The RAM 192 includes an area configured to store computer programs and data loaded from the ROM 193 or an external storage device 196, and an area configured to store data received from the outside via an I/F 197. Also, the RAM 192 includes a work area to be used by the CPU 191 when executing various kinds of processing. In this way, the RAM 192 can appropriately provide various kinds of areas.

Setting data of the cloud server 12, computer programs and data concerning activation of the cloud server 12, computer programs and data concerning the basic operation of the cloud server 12, and the like are stored in the ROM 193.

An operation unit 194 is a user interface such as a keyboard, a mouse, or a touch panel. When a user operates the operation unit 194, various kinds of instructions can be input to the CPU 191.

A display unit 195 includes a screen such as a liquid crystal screen or a touch panel screen and can display a processing result of the CPU 191 by an image or characters. Note that the display unit 195 may be a projection apparatus such as a projector that projects an image or characters.

The external storage device 196 is a mass information storage device such as a hard disk drive. An OS (Operating System) and computer programs and data used to cause the CPU 191 to execute or control various kinds of processing to be explained as processing to be performed by the cloud server 12 are stored in the external storage device 196. The data stored in the external storage device 196 include data concerning the above-described learning models. The computer programs and data stored in the external storage device 196 are appropriately loaded into the RAM 192 under the control of the CPU 191 and processed by the CPU 191.

The I/F 197 is a communication interface configured to perform data communication with the outside, and the cloud server 12 transmits/receives data to/from the outside via the I/F 197. The CPU 191, the RAM 192, the ROM 193, the operation unit 194, the display unit 195, the external storage device 196, and the I/F 197 are connected to a system bus 198. Note that the configuration of the cloud server 12 is not limited to the configuration shown in FIG. 1.

Note that a captured image and Exif information output from the camera 10 may temporarily be stored in a memory of another apparatus and transferred from the memory to the cloud server 12 via the communication network 11.

The information processing apparatus 13 will be described next. The information processing apparatus 13 is a computer apparatus such as a PC (personal computer), a smartphone, or a tablet terminal apparatus. The information processing apparatus 13 presents, to the user, candidates for a learning model presented by the cloud server 12, accepts selection of a learning model from the user, and notifies the cloud server 12 of the learning model selected by the user. Using the learning model notified by the information processing apparatus 13 (a learning model selected from the candidates by the user), the cloud server 12 performs detection (object detection processing) of an image region concerning a crop from the captured image by the camera 10, thereby performing the above-described analysis processing.

A CPU 131 executes various kinds of processing using computer programs and data stored in a RAM 132 or a ROM 133. Accordingly, the CPU 131 controls the operation of the entire information processing apparatus 13, and executes or controls various kinds of processing to be explained as processing to be performed by the information processing apparatus 13.

The RAM 132 includes an area configured to store computer programs and data loaded from the ROM 133, and an area configured to store data received from the camera 10 or the cloud server 12 via an input I/F 135. Also, the RAM 132 includes a work area to be used by the CPU 131 when executing various kinds of processing. In this way, the RAM 132 can appropriately provide various kinds of areas.

Setting data of the information processing apparatus 13, computer programs and data concerning activation of the information processing apparatus 13, computer programs and data concerning the basic operation of the information processing apparatus 13, and the like are stored in the ROM 133.

An output I/F 134 is an interface used by the information processing apparatus 13 to output/transmit various kinds of information to the outside.

An input I/F 135 is an interface used by the information processing apparatus 13 to input/receive various kinds of information from the outside.

A display apparatus 14 includes a liquid crystal screen or a touch panel screen and can display a processing result of the CPU 131 by an image or characters. Note that the display apparatus 14 may be a projection apparatus such as a projector that projects an image or characters.

A user interface 15 includes a keyboard or a mouse. When a user operates the user interface 15, various kinds of instructions can be input to the CPU 131. Note that the configuration of the information processing apparatus 13 is not limited to the configuration shown in FIG. 1, and, for example, the information processing apparatus 13 may include mass information storage device such as a hard disk drive, and computer programs such as a GUI to be described later and data may be stored in the hard disk drive. The user interface 15 may include a touch sensor such as a touch panel.

The procedure of a task of predicting, from an image of a farm field captured by the camera 10, the yield of a crop to be harvested in the farm field in a stage earlier than the harvest time will be described next. If a harvest amount is predicted by simply counting fruit or the like as a harvest target in the harvest time, the purpose can be accomplished by simply detecting a target fruit from a captured image by a discriminator using a method called specific object detection. In this method, since the fruit itself has an extremely characteristic outer appearance, detection is performed by a discriminator that has learned the characteristic outer appearance.

In this embodiment, if a crop is fruit, the fruit is counted after it ripens, and in addition, the yield of the fruit is predicted in a stage earlier than the harvest time. For example, flowers that change to fruit later are detected, and the yield is predicted from the number of flowers. Alternatively, a dead branch or a lesion region where the possibility of fruit bearing is low is detected to predict the yield, or the yield is predicted from the growth state of leaves of a tree. To do such prediction, a prediction method capable of coping with a change in a crop growth state depending on the image capturing time or the climate is necessary. That is, it is necessary to select a prediction method of high prediction performance in accordance with the state of a crop. In this case, it is expected that the above-described prediction is appropriately performed by a learning model that matches the farm field of the prediction target.

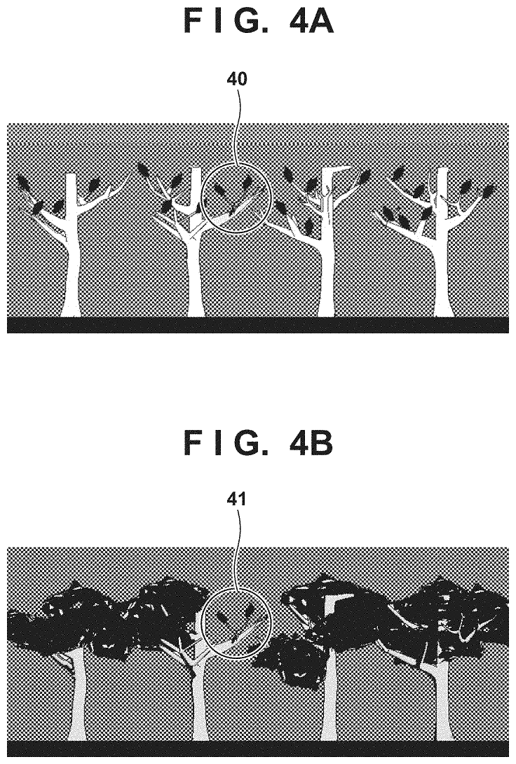

Various objects in the captured image are classified into classes such as a crop tree trunk class, a branch class, a dead branch class, and a post class, and the yield is predicted by the class. Since the outer appearance of an object belonging to a class such as a tree trunk class or a branch class changes depending on the image capturing time, universal prediction is impossible. Such a difficult case is shown in FIGS. 4A and 4B.

FIGS. 4A and 4B show examples of images captured by the camera 10. These captured images include crop trees at almost equal intervals. Since fruit or the like to be harvested is still absent, the task of detecting fruit from the captured image cannot be executed. The trees in the captured image shown in FIG. 4A are crop trees captured in a relatively early stage in the season, and the trees in the captured image shown in FIG. 4B are trees captured in a stage when the leaves have grown to some extent. In the captured image shown in FIG. 4A, since the branches have almost the same number of leaves in all trees, it can be judged that a poor growth region does not exist, and all regions can be determined as harvestable regions. On the other hand, in the captured image shown in FIG. 4B, the growth state of leaves on branches near a center region 41 of the captured image is obviously different from others, and it can easily be judged that the growth is poor. However, the state of the center region 41 (the region with few leaves) can be found as a similar pattern even near a region 40 in the captured image shown in FIG. 4A. The two cases show that an abnormal region of a crop tree cannot be determined by a local pattern. That is, the judgment cannot be done by inputting only a local pattern, as in the above-described specific object detection, and it is necessary to reflect a context obtained from a whole image.

That is, unless the above-described specific object detection is performed using a learning model that has learned using an image obtained by capturing the crop in the same growth state in the past, sufficient performance cannot be obtained.

To cope with every case, for example, not only a case in which an image captured in a new farm field that has never been captured in the past is input or a case in which an image under a condition different from a previous image capturing condition is input due to some external factor such as a long dry spell or extremely large rainfall but also a case in which an image captured by a user in a convenient time is input, a learning model that has learned under a condition close to the condition of the input image needs to be acquired every time.

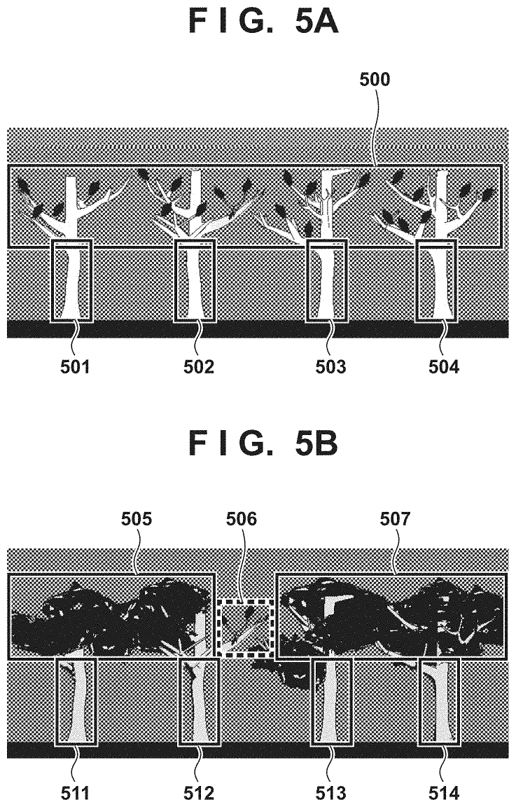

What kind of annotation operation is needed when executing an annotation operation and learning by deep learning every time a farm field is captured will be described here. For example, the results of performing the annotation operation for the captured images shown in FIGS. 4A and 4B are shown in FIGS. 5A and 5B.

Rectangular regions 500 to 504 in the captured image shown in FIG. 5A are image regions designated by the annotation operation. The rectangular region 500 is an image region designated as normal branch region, and the rectangular regions 501 to 504 are image regions designated as tree trunk regions. Since the rectangular region 500 is an image region representing a normal state concerning the growth of trees, the image region is a region largely associated with yield prediction. A region representing a normal state concerning the growth of a tree, like the rectangular region 500, and a region of a portion where fruit or the like can be harvested will be referred to as production regions hereinafter.

Rectangular regions 505 to 507 and 511 to 514 in the captured image shown in FIG. 5B are image regions designated by the annotation operation. The rectangular regions 505 and 507 are image regions designated as normal branch regions, and the rectangular region 506 is an image region designated as an abnormal dead branch region. A region representing an abnormal state, like the rectangular region 506, and a region of a portion where fruit or the like cannot be harvested will be referred to as nonproductive regions. The rectangular regions 511 to 514 are image regions designated as tree trunk regions. Since image regions judged as regions (production regions) where fruit or the like can be harvested are the rectangular regions 505 and 507, the image regions 505 and 507 are regions largely associated with yield prediction.

When such an annotation operation is executed for a number of (for example, several hundred to several thousand) captured images every time a farm field is captured, it takes a very high cost. In this embodiment, a satisfactory prediction result is acquired without executing such a more cumbersome annotation operation. In this embodiment, a learning model is acquired by deep learning. However, the learning model acquisition method is not limited to a specific acquisition method. In addition, various object detectors may be applied in place of a learning model.

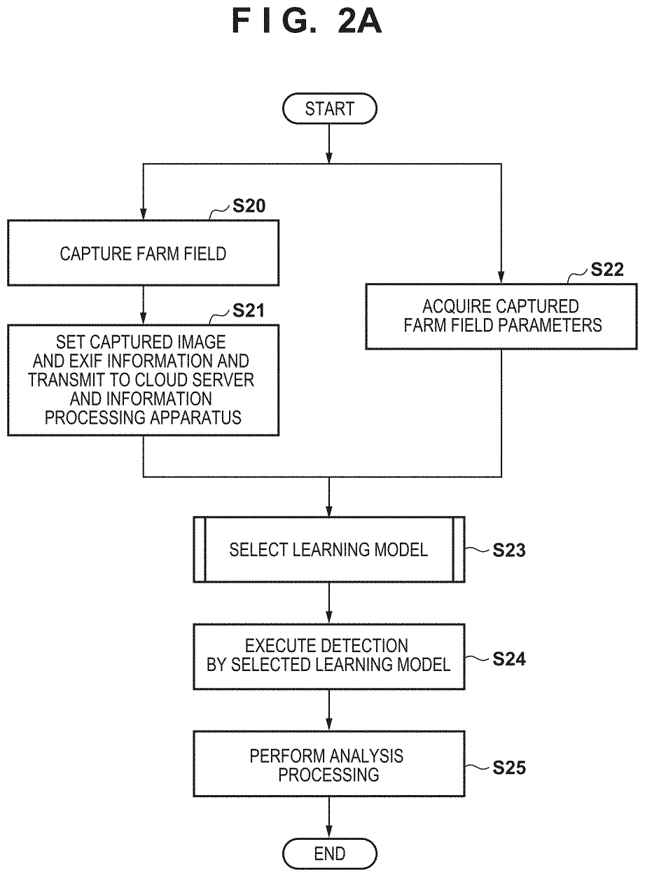

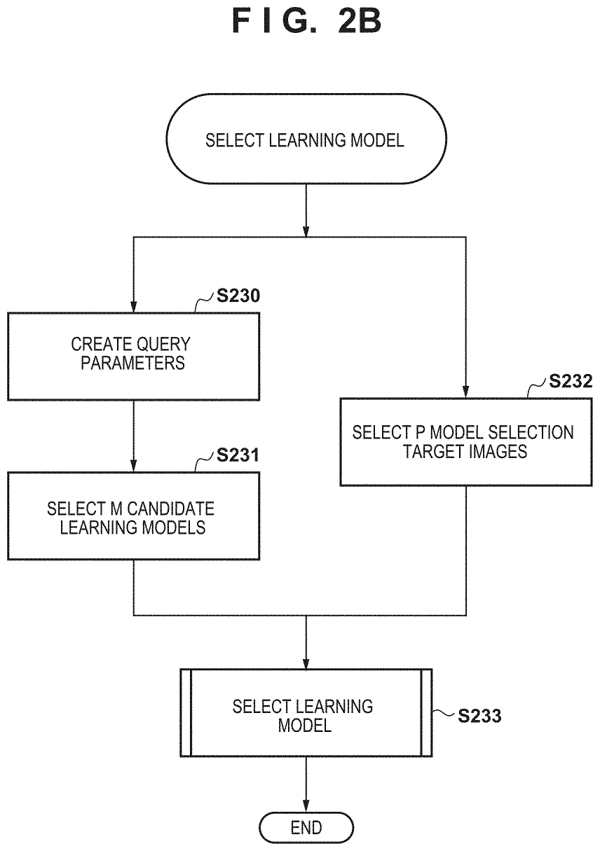

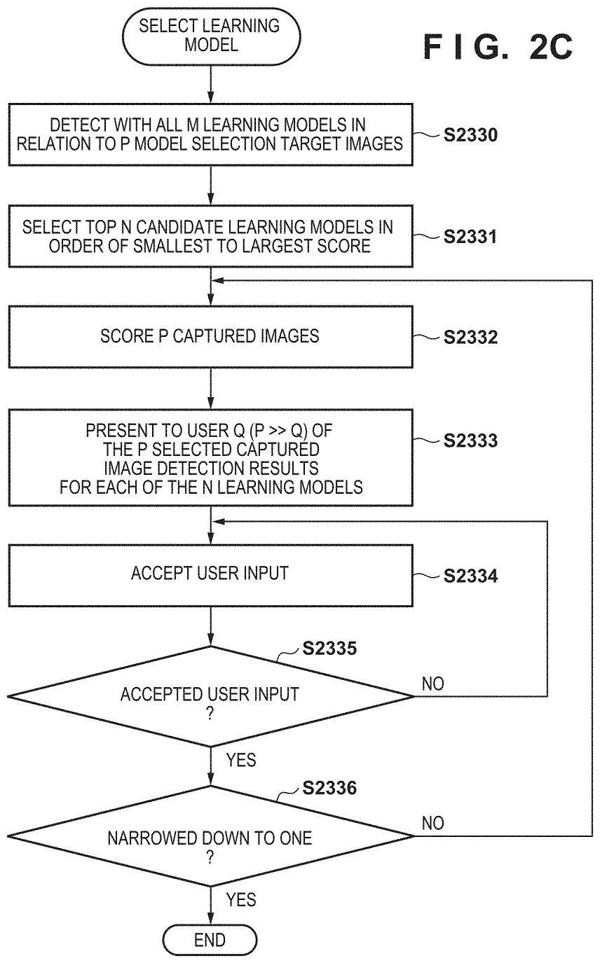

Processing to be performed by the system according to this embodiment to perform analysis processing based on images of a farm field captured by the camera 10, such as prediction of the yield in the farm field or calculation of nonproductivity on the entire farm field will be described next with reference to the flowchart of FIG. 2A.

In step S20, the camera 10 captures a farm field during movement of a moving body such as the tractor 32 for agricultural work or the drone 37, thereby generating captured images of the farm field.

In step S21, the camera 10 attaches the above-described Exif information (image capturing information) to the captured images generated in step S20, and transmits the captured images with the Exif information to the cloud server 12 and the information processing apparatus 13 via the communication network 11.

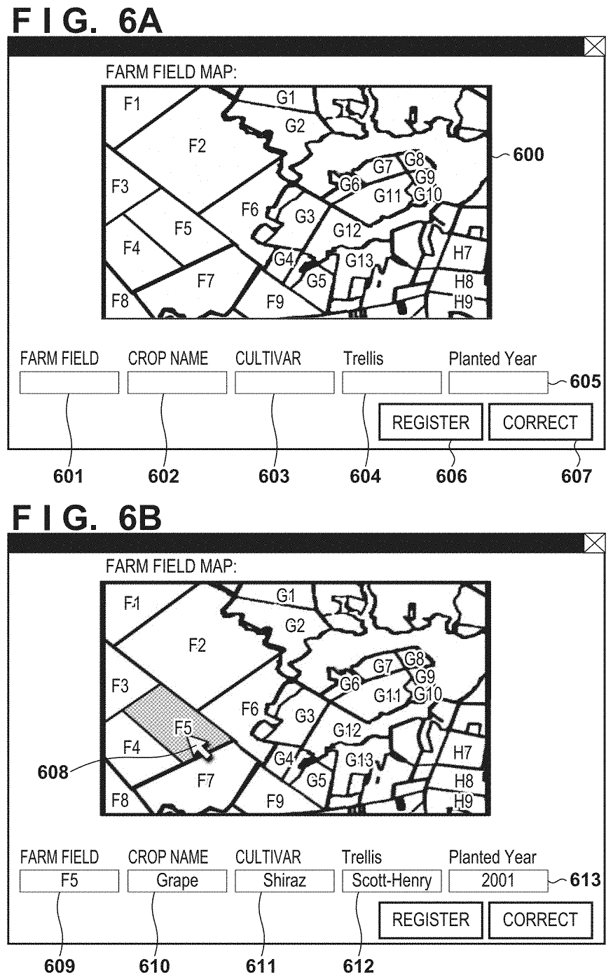

In step S22, the CPU 131 of the information processing apparatus 13 acquires information concerning the farm field captured by the camera 10, the crop, and the like (the cultivar of the crop, the age of trees, the growing method and the pruning method of the crop, and the like) as captured farm field parameters. For example, the CPU 131 displays a GUI (Graphical User Interface) shown in FIG. 6A on the display apparatus 14 and accepts input of captured farm field parameters from the user.

On the GUI shown in FIG. 6A, the map of the entire farm field is displayed in a region 600. The map of the farm field displayed in the region 600 is divided into a plurality of sections. In each section, an identifier (ID) unique to the section is displayed. The user designates a portion in the region 600 corresponding to the section captured by the camera 10 (that is, the section for which the above-described analysis processing should be performed) or inputs the identifier of the section to a region 601 by operating the user interface 15. If the user designates a portion in the region 600 corresponding to the section captured by the camera 10 by operating the user interface 15, the identifier of the section is displayed in the region 601.

The user can input a crop name (the name of a crop) to a region 602 by operating the user interface 15. Also, the user can input the cultivar of the crop to a region 603 by operating the user interface 15. In addition, the user can input Trellis to a region 604 by operating the user interface 15. For example, if the crop is a grape, Trellis means a grape tree design method used to grow a grape in a grape farm field. Also, the user can input Planted Year to a region 605 by operating the user interface 15. For example, if the crop is a grape, Planted Year means the time when grape tree was planted. Note that it is not essential to input the captured farm field parameters for all the items.

When the user instructs a registration button 606 by operating the user interface 15, the CPU 131 of the information processing apparatus 13 transmits, to the cloud server 12, the captured farm field parameters of the items input on the GUI shown in FIG. 6A. The CPU 191 of the cloud server 12 stores (registers), in the external storage device 196, the captured farm field parameters transmitted from the information processing apparatus 13.

When the user instructs a correction button 607 by operating the user interface 15, the CPU 131 of the information processing apparatus 13 enables correction of the captured farm field parameters input on the GUI shown in FIG. 6A.

The GUI shown in FIG. 6A is a GUI particularly configured to cause the user to input captured farm field parameters assuming management of a grape farm field. Even if the purpose is the same, the captured farm field parameters to be input by the user are not limited to those shown in FIG. 6A. Even if the crop is not a grape, the captured farm field parameters to be input by the user are not limited to those shown in FIG. 6A. For example, when the crop name input to the region 602 is changed, the titles of the regions 603 to 605 and the captured farm field parameters to be input may be changed.

Basically, once the captured farm field parameters input on the GUI shown in FIG. 6A are decided, these can be used as fixed parameters. For this reason, if the yield is predicted by capturing the farm field every year, the already registered captured farm field parameters can be invoked and used. If captured farm field parameters are already registered concerning a desired section, the captured farm field parameters corresponding to the section are displayed in regions 609 to 613 next time, as shown in FIG. 6B, by simply instructing a portion of the region 600 corresponding to the desired section.

Inputting all correct captured farm field parameters is preferable to select a learning model in a subsequent stage. However, even if a captured farm field parameter cannot be input because it is unknown for the user, subsequent processing can be performed without knowing the parameter.

In step S23, processing for selecting candidates for a learning model used to detect an object such as a crop from a captured image is performed. Details of the processing in step S23 will be described with reference to the flowchart of FIG. 2B.

In step S230, the CPU 191 of the cloud server 12 generates a query parameter based on Exif information attached to each captured image acquired from the camera 10 and the captured farm field parameters (the captured farm field parameters of the section corresponding to the captured images) registered in the external storage device 196.

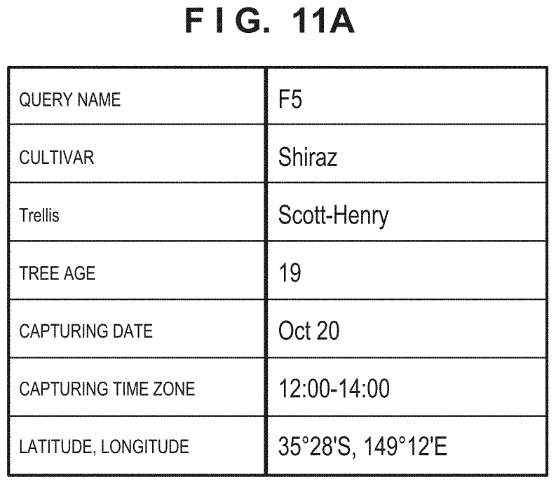

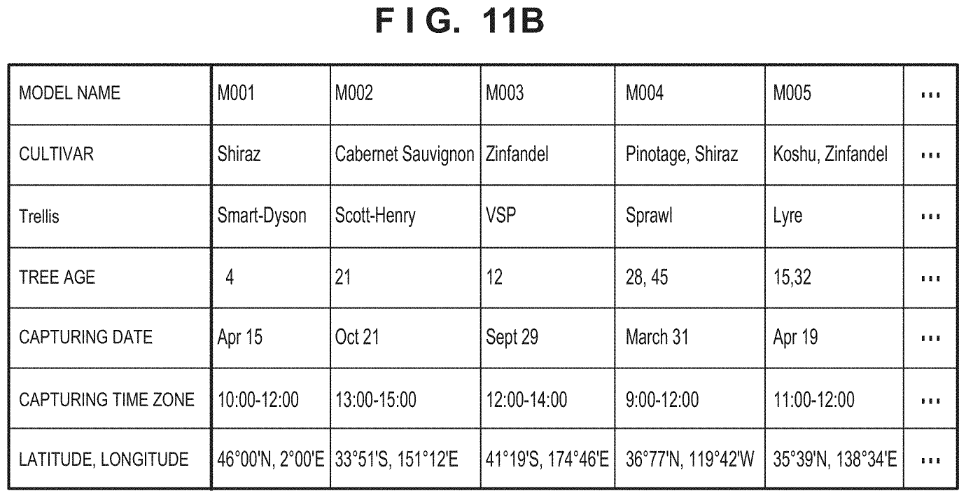

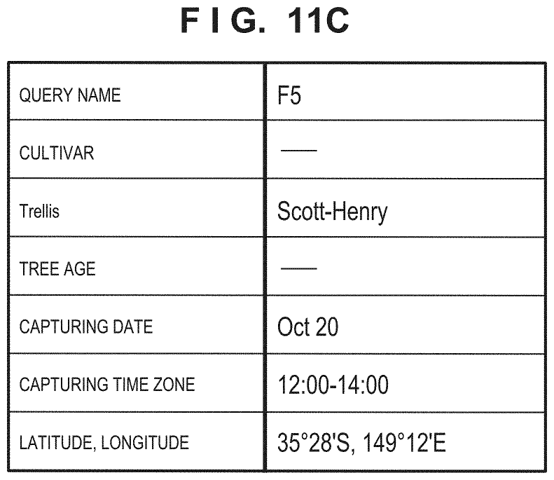

FIG. 11A shows an example of the configuration of a query parameter. The query parameter shown in FIG. 11A is a query parameter generated when the captured farm field parameters shown in FIG. 6B are input.

“F5” input to the region 609 is set in “query name”. “Shiraz” input to the region 611 is set in “cultivar”. “Scott-Henry” input to the region 612 is set in “Trellis”. The number of years elapsed from “2001” input to the region 613 to the image capturing date/time (year) included in the Exif information is set as a tree age “19” in “image capturing date”. An image capturing date/time (date) “October 20” included in the Exif information is set in “image capturing date”. A time zone “12:00-14:00” from the earliest image capturing date/time (time) to the latest image capturing date/time (time) in the image capturing dates (times) in the Exif information attached to the captured images received from the camera 10 is set in “image capturing time zone”. An image capturing position “35° 28'S, 149° 12″E” included in the Exif information is set in “latitude/longitude”.

Note that the query parameter generation method is not limited to the above-described method, and, for example, data already used in farm field management by the farmer of the crop may be loaded, and a set of parameters that match the above-described items may be set as a query parameter.

Note that in some cases, information concerning some items may be unknown. For example, if information concerning the Planted Year or the cultivar is unknown, all items as shown in FIG. 11A cannot be filled. In this case, some of the fields of the query parameter are blank, as shown in FIG. 11C.

Next, in step S231, the CPU 191 of the cloud server 12 selects M (1≤M<E) learning models (candidate learning models) that are candidates in E (E is an integer of 2 or more) learning models stored in the external storage device 196. In the selection, learning models that have learned based on an environment similar to the environment represented by the query parameter are selected as the candidate learning models. A parameter set representing what kind of environment was used by a learning model for learning is stored in the external storage device 196 for each of the E learning models. FIG. 11B shows an example of the configuration of a parameter set of each learning model in the external storage device 196.

“Model name” is the name of a learning model, “cultivar” is the cultivar of a crop learned by the learning model, and “Trellis” is “the grape tree design method used to grow a grape in a grape farm field”, which was learned by the learning model. “Tree age” is the age of the crop learned by the learning model, and “image capturing date” is the image capturing date/time of a captured image of the crop used by the learning model for learning. “Image capturing time zone” is the period from the earliest image capturing date/time to the latest image capturing date/time in the captured images of the crop, which was used by the learning model for learning, and “latitude/longitude” is the image capturing position “35°28′S, 149°12″E” of the captured image of the crop used by the learning model for learning model.

Some learning models perform learning using a mixture of data sets collected in a plurality of farm field blocks. Hence, a parameter set including a plurality of settings (cultivars and tree ages) may be set, like, for example, learning models of model names “M004” and “M005”.

Hence, the CPU 191 of the cloud server 12 obtains the similarity between the query parameter and the parameter set of each learning model shown in FIG. 11B, and selects, as the candidate learning models, M high-rank learning models in the descending order of similarity.

When the parameter sets of the learning models of model names=M001, M002, . . . , are expressed as M1, M2, . . . , the CPU 191 of the cloud server 12 obtains a similarity D(Q,Mₓ) between a query parameter Q and a parameter set Mₓ by calculating

$$D ( Q , {M}_{x} ) {\sum }_{k} {α}_{k} \cdot {f}_{x} ( {q}_{k} {m}_{x , k} ) , 1 \leq k \qquad ( 1 )$$

where qₖ indicates the kth element from the top of the query parameter Q. In the case of FIG. 11A, since the query parameter Q includes six elements “cultivar”, “Trellis”, “tree age”, “image capturing date”, “image capturing time zone”, and “latitude/longitude”, k=1 to 6.

m_{x,k} indicates the kth element from the top of the parameter set Mₓ. In the case of FIG. 11B, since the parameter set includes six elements “cultivar”, “Trellis”, “tree age”, “image capturing date”, “image capturing time zone”, and “latitude/longitude”, k=1 to 6.

fₖ(aₖ,bₖ) is a function for obtaining the distance between elements aₖ and bₖ and is set in advance. fₖ(aₖ,bₖ) may be carefully set in advance by experiments. As for the distance definition by equation (1), basically, the distance preferably has a large value in a learning model of a different characteristic. Hence, fₖ(aₖ,bₖ) is simply set as follows.

That is, the elements are basically divided into two types, that is, classification elements (cultivar and Trellis) and continuous value elements (tree age, image capturing date, . . . ) Hence, a function for defining the distance between classification elements is defined by equation (2), and a function for defining the distance between continuous value elements is defined by equation (3).

$${f}_{k} ( {q}_{k} , {m}_{x , k} ) = \{ \begin{matrix}0 & ( {q}_{k} = {m}_{x , k} ) \\ 1 & ( {q}_{k} \neq {m}_{x , k} )\end{matrix} \\ {f}_{k} ( {q}_{k} , {m}_{x , k} ) = \vert {q}_{k} - {m}_{x , k} \vert \qquad ( 2 )$$

Functions for all elements (k) are implemented in advance on a rule base. In addition, αₖ is obtained in accordance with the degree of influence on the final inter-model distance of each element. For example, adjustment is performed in advance such that α₁ is made close to 0 as much as possible because the difference by “cultivar” (k=1) does not appear as a large difference between images, and α₂ is set large because the difference by “Trellis” (k=2) has a great influence.

Also, in a learning model in which a plurality of settings are registered in “cultivar” or “tree age”, like the learning models of model names “M004” and “M005” in FIG. 11B, for, for example, “cultivar”, the distance is obtained for each setting registered in “cultivar”, and the average distance is obtained as the distance corresponding to “cultivar”. For “tree age” as well, the distance is obtained for each setting registered in “tree age”, and the average distance is obtained as the distance corresponding to “tree age”.

Note that the selection method is not limited to a specific selection method if the CPU 191 of the cloud server 12 selects M learning models as candidate learning models based on the above-described similarity. For example, the CPU 191 of the cloud server 12 may select M learning models having a similarity equal to or more than a threshold.

If all elements in a query parameter are blank, the processing of step S231 is not performed, and as a result, subsequent processing is performed using all learning models as candidate learning models.

There are various effects of selection of candidate learning modes. First, when learning models of low possibility are excluded in this step based on prior knowledge, the processing time needed for subsequent ranking creation by scoring of learning models or the like can greatly be shortened. Also, in scoring of learning models on a rule base, if a learning model that need not be compared is included in the candidates, the learning model selection accuracy may lower. However, candidate learning model selection can minimize the possibility.

Next, in step S232, the CPU 191 of the cloud server 12 selects, as model selection target images, P (P is an integer of 2 or more) captured images from the captured images received from the camera 10. The method of selecting P captured images from the captured images received from the camera 10 is not limited to a specific selection method. For example, the CPU 191 may select P captured images at random from the captured images received from the camera 10, or may be selected in accordance with a certain criterion.

Next, in step S233, processing for selecting one of the M candidate learning models as a selected learning model using the P captured images selected in step S232 is performed. Details of the processing in step S233 will be described with reference to the flowchart of FIG. 2C.

In step S2330, for each of the M candidate learning models, the CPU 191 of the cloud server 12 performs “object detection processing that is processing of detecting, for each of the P captured images, an object from the captured image using the candidate learning model”.

Accordingly, for each of the P captured images, “the result of object detection processing for the captured image” is obtained for each of the M candidate learning models. In this embodiment, “the result of object detection processing for the captured image” is the position information of the image region (the rectangular region or the detection region) of an object detected from the captured image.

In step S2331, the CPU 191 obtains a score for “the result of object detection processing for each of the P captured images” in correspondence with each of the M candidate learning models. The CPU 191 then performs ranking (ranking creation) of the M candidate learning models based on the scores, and selects N (N≤M) candidate learning models from the M candidate learning models.

At this time, since the captured images have no annotation information, correct detection accuracy evaluation cannot be done. However, in a target that is intentionally designed and maintained, like a farm, the accuracy of object detection processing can be predicted and evaluated using the following rules. A score for the result of object detection processing by a candidate learning model is obtained, for example, in the following way.

In a general farm, crops are planted at equal intervals, as shown in FIGS. 3A and 3B. Hence, when objects are detected like annotations (rectangular regions) shown in FIGS. 5A and 5B, the rectangular regions are always equally detected continuously from the left end to the right end of the image in a normal detection state.

For example, as shown in FIG. 5A, if all regions from the left end to the right end of a captured image are detected as regions where fruit or the like can be harvested, the production region should be detected like the rectangular region 500. Also, even if the rectangular region 506 that is a nonproductive region exists in the captured image, as shown in FIG. 5B, the rectangular regions 505, 506, and 507 should be detected from the left end to the right end of the captured image. If object detection processing for a captured image is executed using a learning model that does not match the condition of the captured image, an undetected rectangular region may occur among the rectangular regions. The farther the condition to which the learning model corresponds to is from the condition of the captured image, the higher the possibility becomes. Hence, as the simplest scoring method for evaluating a candidate learning model, for example, the following method can be considered.

By a candidate learning model of interest, detection regions of a plurality of objects are detected from the captured image of interest. Hence, a detection region is searched for in the vertical direction of the captured image of interest, the number Cp of pixels of a region where the detection region is absent is counted, and the ratio of the number Cp of pixels to the number of pixels of the width of the captured image of interest is obtained as the penalty score of the captured image of interest. In this way, the penalty score is obtained for each of the P captured images that have undergone the object detection processing using the candidate learning model of interest, and the sum of the obtained penalty scores is set to the score of the candidate learning model of interest. When this processing is performed for each of the M candidate learning models, the score of each candidate learning model is determined. The M candidate learning models are ranked in the ascending order of score, and N high-rank candidate learning models are selected in the ascending order of score. At the time of selection, a condition that “the score is less than a threshold” may be added.

In addition, as the score of a candidate learning model, a score estimated from the detection regions of the trunk portions of trees normally planted at equal intervals may be obtained. Since the trunks of trees should be detected at almost equal intervals as the rectangular regions 501, 502, 503, and 504, as shown in FIG. 5A, the number assumed as “the number of detected tree trunk regions” with respect to the width of a captured image is determined in advance. Since a captured image in which the number is smaller/larger than the assumed number includes a detection error at a high possibility, the number of detected regions may be reflected in the score.

The CPU 191 then transmits, to the information processing apparatus 13, the P captured images, “the result of object detection processing for the P captured images” obtained for each of the N candidate learning models selected from the M candidate learning models, information (a model name and the like) concerning the N candidate learning models, and the like. As described above, in this embodiment, “the result of object detection processing for a captured image” is the position information of the image region (the rectangular region or the detection region) of an object detected from the captured image. Such position information is transmitted to the information processing apparatus 13 as, for example, data in a file format such as the j son format or the txt format.

Next, the user is caused to select one of the N selected candidate learning models. N candidate learning models still remain at the end of the processing of step S2331. An output as the base for performance comparison is the result of object detection processing for the P captured images. For this reason, the user needs to compare the results of object detection processing for the N×P captured images. In this state, it is difficult to appropriately select one candidate learning model as a selected learning model (narrow down the candidates to one learning model).

Hence, in step S2332, for the P captured image, the CPU 131 of the information processing apparatus 13 performs scoring (display image scoring) for presenting information that facilitates comparison by the subjectivity of the user. In the display image scoring, a score is decided for each of the P captured images, such that the larger the difference in the arrangement pattern of detection regions is between the N candidate learning models, the higher the score becomes. Such a score can be obtained by calculating, for example,

$$Score ( z ) = {\sum }_{a \neq b} {\sum }_{b = 0}^{N - 1} {T}_{{I}_{2}} ( {M}_{a} , {M}_{b} ) , 0 \leq z \leq P - 1 \qquad ( 4 )$$

where Score(z) is the score for a captured image I_{z}. T_{I}_{_{z}}(Mₐ,M_{b}) is a function for obtaining a score based on the difference between the result (detection region arrangement pattern) of object detection processing performed for the captured image I_{z} by a candidate learning model Mₐ and the result (detection region arrangement pattern) of object detection processing performed for the captured image I_{z} by a candidate learning model M_{b}. Various functions can be applied to the function, and the function is not limited to a specific function. For example, a function of obtaining, for each detection region Ra detected from the captured image I_{z} by the candidate learning model Mₐ, the difference between the position (for example, the position of the upper left corner and the position of the lower right corner) of a detection region R_{b}′ closest to the detection region Ra in a detection region R_{b} detected from the captured image I_{z} by the candidate learning model M_{b} and the position (for example, the position of the upper left corner and the position of the lower right corner) of the detection region Ra, and returning the sum of obtained differences may be used as T_{I}_{_{z}}(Mₐ,M_{b}).

Since the results of object detection processing by the N high-rank candidate learning models are similar in many cases, the difference is almost absent between images extracted at random, and the base in selecting a candidate learning model cannot be obtained. Hence, whether a learning model is appropriate or not can easily be judged by seeing only high-rank captured images scored by equation (4) above.

In step S2333, the CPU 131 of the information processing apparatus 13 causes the display apparatus 14 to display, for each of the N candidate learning models, F high-rank captured images (a predetermined number of captured images from the top) in the descending order of score in the P captured images received from the cloud server 12 and the results of object detection processing for the captured images received from the cloud server 12 (display control). At this time, the F captured images are arranged and displayed from the left side in the descending order of score.

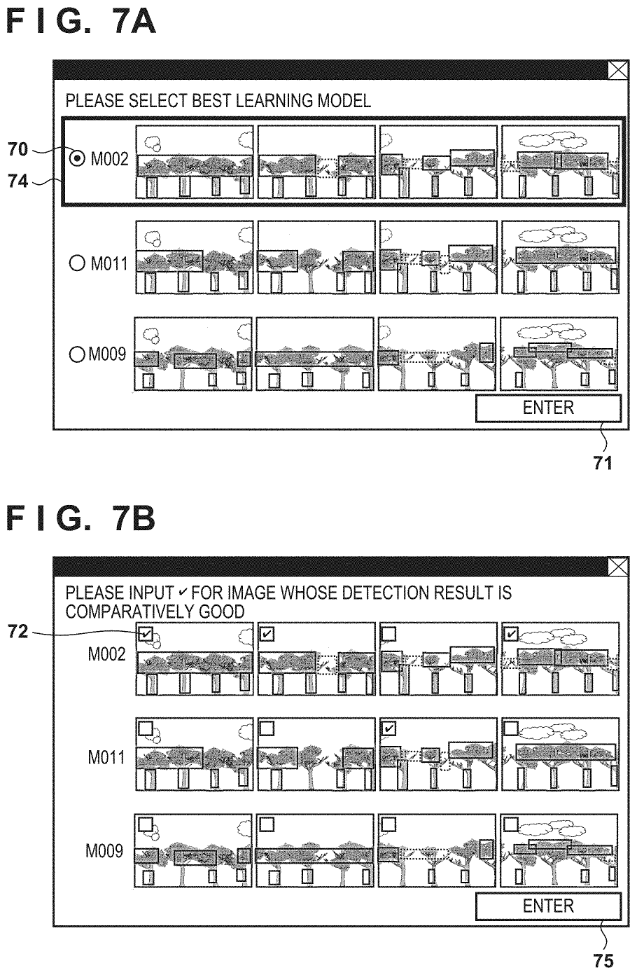

FIG. 7A shows a display example of a GUI that displays captured images and results of object detection processing for each candidate learning model. FIG. 7A shows a case in which N=3, and F=4.

In the uppermost row, the model name “M002” of the candidate learning model with the highest score is displayed together with a radio button 70. On the right side, four high-rank captured images are arranged and displayed sequentially from the left side in the descending order of score. Frames representing the detection regions of objects detected from the captured images by the candidate learning model of the model name “M002” are superimposed on the captured images.

In the row of the middle stage, the model name “M011” of the candidate learning model with the second highest score is displayed together with the radio button 70. On the right side, four high-rank captured images are arranged and displayed sequentially from the left side in the descending order of score. Frames representing the detection regions of objects detected from the captured images by the candidate learning model of the model name “M011” are superimposed on the captured images.

In the row of the lower stage, the model name “M009” of the candidate learning model with the third highest score is displayed together with the radio button 70. On the right side, four high-rank captured images are arranged and displayed sequentially from the left side in the descending order of score. Frames representing the detection regions of objects detected from the captured images by the candidate learning model of the model name “M009” are superimposed on the captured images.

Note that on this GUI, to allow the user to easily compare the results of object detection processing by the candidate learning models at a glance, display is done such that identical captured images are arranged on the same column.

The user visually confirms the difference between the results of object detection processing for the F captured images by the N candidate learning models, and selects one of the N candidate learning models using the user interface 15.

In step S2334, the CPU 131 of the information processing apparatus 13 accepts the candidate learning model selection operation (a user operation or user input) by the user. In step S2335, the CPU 131 of the information processing apparatus 13 judges whether the candidate learning model selection operation (user input) by the user is performed.

In the case shown in FIG. 7A, to select the candidate learning model of the model name “M002”, the user selects the radio button 70 on the uppermost row using the user interface 15. To select the candidate learning model of the model name “M011”, the user selects the radio button 70 on the row of the middle stage using the user interface 15. To select the candidate learning model of the model name “M009”, the user selects the radio button 70 on the row of the lower stage using the user interface 15. Since the radio button 70 corresponding to the model name “M002” is selected in FIG. 7A, a frame 74 indicating that the candidate learning model of the model name “M002” is selected is displayed.

When the user instructs the decision button 71 by operating the user interface 15, the CPU 131 judges that “the candidate learning model selection operation (user input) by the user is performed”, and selects the candidate learning model corresponding to the selected radio button 70 as a selected learning model.

As the result of judgment, if the candidate learning model selection operation (user input) by the user is performed, the process advances to step S2336. If the candidate learning model selection operation (user input) by the user is not performed, the process returns to step S2334.

In step S2336, the CPU 131 of the information processing apparatus 13 confirms whether it is a state in which only one learning model is finally selected. If it is a state in which only one learning model is finally selected, the process advances to step S24. If it is not a state in which only one learning model is finally selected, the process returns to step S2332.

If the user cannot narrow down the candidates to one only by seeing the display in FIG. 7A, a plurality of candidate learning models may be selected by selecting a plurality of radio buttons 70. For example, if the user designates the radio button 70 corresponding to the model name “M002” and the radio button 70 corresponding to the model name “M011” in FIG. 7A and designates a decision button 71 by operating the user interface 15, the number “2” of selected radio buttons 70 is set to N, and the process returns to step S2332 via step S2336. In this case, the same processing as described above is performed for N=2, and F=4 from step S2332. In this way, the processing is repeated until the number of finally selected learning models equals “1”.

Alternatively, the user may select a learning model using a GUI shown in FIG. 7B in place of the GUI shown in FIG. 7A. The GUI shown in FIG. 7A is a GUI configured to cause the user to directly select which learning model is appropriate. On the other hand, on the GUI shown in FIG. 7B, a check box 72 is provided on each captured image. For the captured images vertically arranged in each column, the user turns on (adds a check mark to) the check box 72 of a captured image judged to have a satisfactory result of object detection processing in the column of captured images by operating the user interface 15 to designate it. When the user instructs a decision button 75 by operating the user interface 15, the CPU 131 of the information processing apparatus 13 selects, from the candidate learning models of the model names “M002”, “M011”, and “M009”, a candidate learning model in which the number of captured images whose check boxes 72 are ON is largest as a selected learning model. In the example shown in FIG. 7B, the check boxes 72 are ON in three of the four captured images of the candidate learning model whose model name is “M002”, the check box 72 is ON in one of the four captured images of the candidate learning model whose model name is “M011”, and the check box 72 is not ON in any of the four captured images of the candidate learning model whose model name is “M009”. In this case, the candidate learning model of the model name “M002” is selected as the selected learning model. The selected learning model selection method using such a GUI is effective in a case in which, for example, the value F increases, and it is difficult for the user to judge which candidate learning model is best.

Note that if candidate learning models in which “the numbers of captured images whose check boxes 72 are ON” are equal or slightly different exist, it is judged in step S2336 that “it is not a state in which only one learning model is finally selected”, and the process returns to step S2332. From step S2332, processing is performed for the candidate learning models in which “the numbers of captured images whose check boxes 72 are ON” are equal or slightly different. Even in this case, the processing is repeated until the number of finally selected learning models equals “1”.

In addition, since a captured image displayed on the left side is a captured image for which the difference in the result of object detection processing between the candidate learning models is large, a large weight value may be assigned to the captured image displayed on the left side. In this case, the sum of the weight values of the captured images whose check boxes 72 are ON is obtained for each candidate learning model, and the candidate learning model for which the obtained sum is largest may be selected as a selected learning model.

Independently of the method used to select the selected learning model, the CPU 131 of the information processing apparatus 13 notifies the cloud server 12 of information representing the selected learning model (for example, the model name of the selected learning model).

In step S24, the CPU 191 of the cloud server 12 performs object detection processing for the captured image (the captured image transmitted from the camera 10 to the cloud server 12 and the information processing apparatus 13) using the selected learning model specified by the information notified from the information processing apparatus 13.

In step S25, the CPU 191 of the cloud server 12 performs analysis processing such as prediction of a yield in the target farm field and calculation of nonproductivity for the entire farm field based on the detection region obtained as the result of object detection processing in step S24. This calculation is done in consideration of both production region rectangles detected from all captured images and nonproductive regions determined as a dead branch region, a lesion region, or the like.

Note that the learning model according to this embodiment is a model learned by deep learning. However, various object detection techniques such as a detector, a fuzzy inference, or a genetic algorithm on a rule base defined by various kinds of parameters may be used as a learning model.

### Second Embodiment

From this embodiment, the difference from the first embodiment will be described, and the remaining is assumed to be the same as in the first embodiment unless it is specifically stated otherwise below. In this embodiment, a system that performs visual inspection in a production line of a factory will be described as an example. The system according to this embodiment detects an abnormal region of an industrial product that is an inspection target.

Conventionally, in visual inspection in a production line of a factory, the image capturing conditions and the like of an inspection apparatus (an apparatus that captures and inspects the outer appearance of a product) are carefully adjusted on a manufacturing line basis. In general, every time a manufacturing line is started up, time is taken to adjust the settings of an inspection apparatus. In recent years, however, a manufacturing site is required to immediately cope with diverse customer needs and a change of a market. Even in a small lot, there are increasing needs to quickly start up a line in a short period, manufacture a quantity of products meeting demands, and after sufficient supply, immediately deconstruct the line to prepare the next manufacturing line.

At this time, if the settings of visual inspection are done each time based on the experience and intuition of a specialist on the manufacturing site as in a conventional manner, it is impossible to cope with speedy startup. In a case in which inspection of similar products was executed in the past, if setting parameters concerning these are held, and the past setting parameters can be invoked for similar inspection, anyone can do the settings of the inspection apparatus without depending on the experience of the specialist.

As in the first embodiment, an already held learning model is assigned to an inspection target image of a new product, thereby achieving the above-described purpose. Hence, the above-described information processing apparatus 13 can be applied to the second embodiment as well.

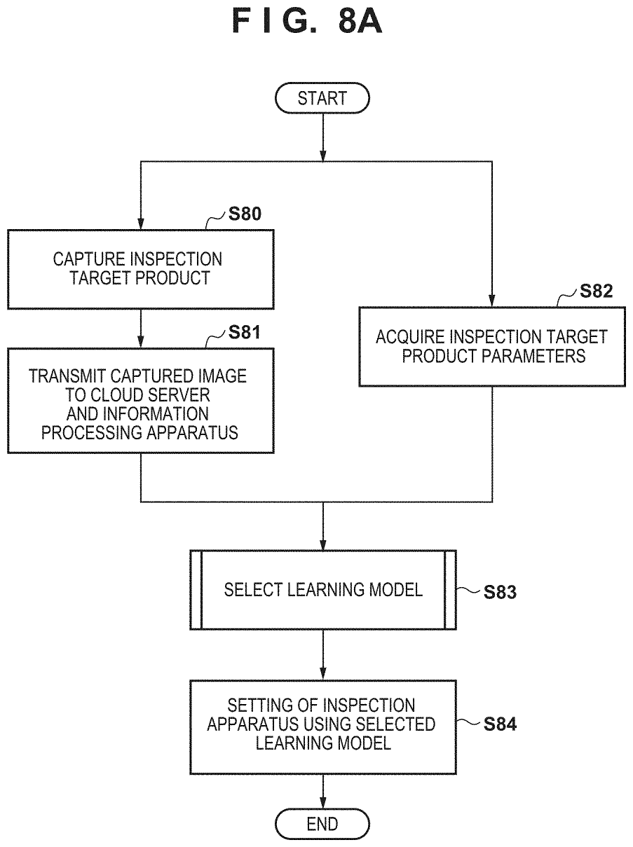

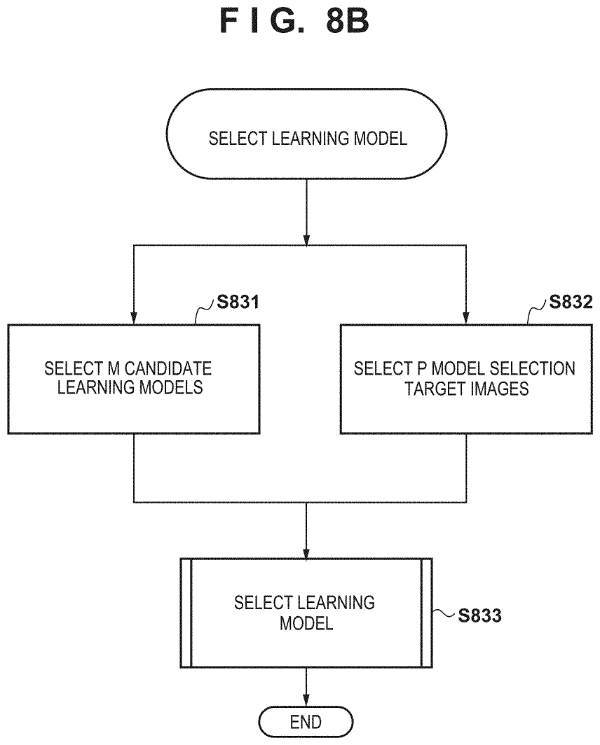

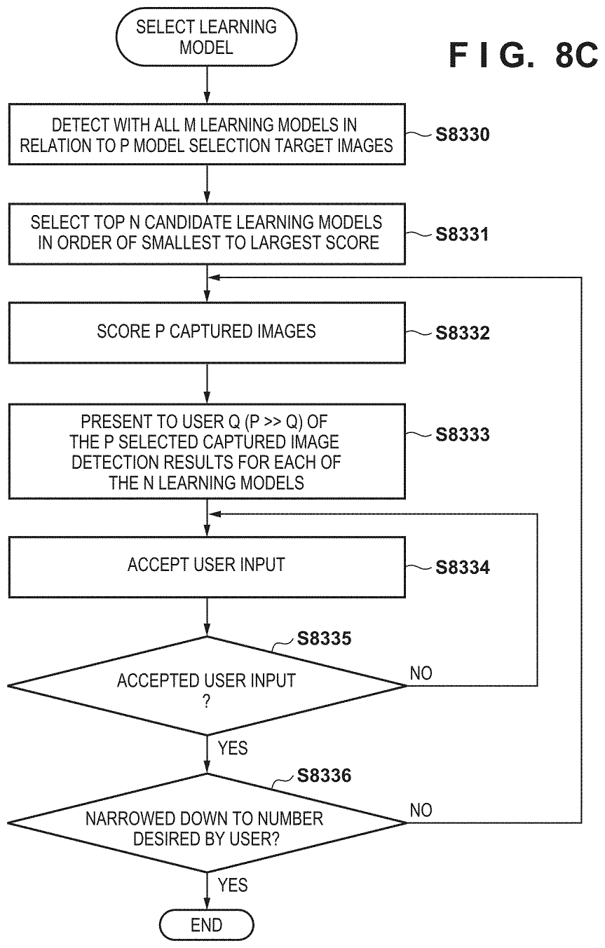

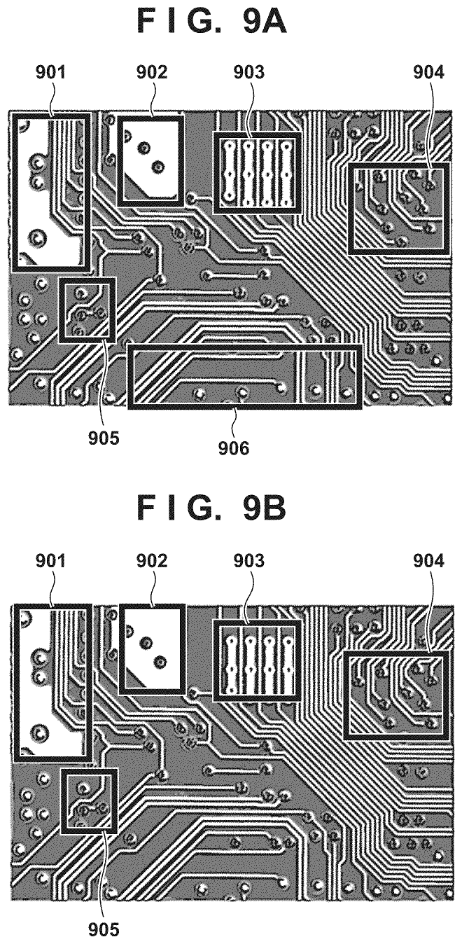

Inspection apparatus setting processing (setting processing for visual inspection) by the system according to this embodiment will be described with reference to the flowchart of FIG. 8A. Note that the setting processing for visual inspection is assumed to be executed at the time of startup of an inspection step in a manufacturing line.

A plurality of learning models (visual inspection models/settings) used to perform visual inspection in a captured image are registered in an external storage device 196 of a cloud server 12. The learning models are models learned under learning environments different from each other.

A camera 10 is a camera configured to capture a product (inspection target product) that is a target of visual inspection. As in the first embodiment, the camera 10 may be a camera that periodically or non-periodically performs image capturing, or may be a camera that captures a moving image. To correctly detect an abnormal region of an inspection target product from a captured image, if an inspection target product including an abnormal region enters the inspection step, image capturing is preferably performed under a condition for enhancing the abnormal region as much as possible. The camera 10 may be a multi-camera if the inspection target product is captured under a plurality of conditions.

In step S80, the camera 10 captures the inspection target product, thereby generating a captured image of the inspection target product. In step S81, the camera 10 transmits the captured image generated in step S80 to the cloud server 12 and an information processing apparatus 13 via a communication network 11.

In step S82, a CPU 131 of the information processing apparatus 13 acquires, as inspection target product parameters, information (the part name and the material of the inspection target product, the manufacturing date, image capturing system parameters in image capturing, the lot number, the atmospheric temperature, the humidity, and the like) concerning the inspection target product and the like captured by the camera 10. For example, the CPU 131 causes a display apparatus 14 to display a GUI and accepts input of inspection target product parameters from the user. When the user inputs a registration instruction by operating a user interface 15, the CPU 131 of the information processing apparatus 13 transmits, to the cloud server 12, the inspection target product parameters of the above-described items input on the GUI. The CPU 191 of the cloud server 12 stores (registers), in the external storage device 196, the inspection target product parameters transmitted from the information processing apparatus 13.

In step S83, processing for selecting a learning model to be used to detect the above-described inspection target product from a captured image is performed. Details of the processing in step S83 will be described with reference to the flowchart of FIG. 8B.

In step S831, the CPU 191 of the cloud server 12 selects M learning models (candidate learning models) as candidates from E learning models stored in the external storage device 196. The CPU 191 generates a query parameter from the inspection target product parameters registered in the external storage device 196, as in the first embodiment, and selects learning models that have learned in an environment similar to the environment indicated by the query parameter (learning models used in similar inspection in the past).

If “base” is included as “part name” in the query parameter, a learning model used in base inspection in the past is easily selected. Also, if “glass epoxy” is included as “material”, a learning model used in inspection of a glass epoxy base is easily selected.

In step S831 as well, M candidate learning models are selected using the parameter sets of learning models and the query parameter, as in the first embodiment. At this time, equation (1) described above is used as in the first embodiment.

Next, in step S832, the CPU 191 of the cloud server 12 selects, as model selection target images, P captured images from the captured images received from the camera 10. For example, products transferred to the inspection step of the manufacturing line are selected at random, and P captured images are acquired from images captured by the camera 10 under the same settings as in the actual operation. The number of abnormal products that occur in the manufacturing line is normally small. For this reason, if the number of products captured in the step is small, processing in the subsequent steps does not function well. Hence, at least almost several hundred products are preferably captured.

Next, in step S833, using the P captured images selected in step S832, processing for selecting one selected learning model from the M candidate learning models is performed. Details of the processing in step S833 will be described with reference to the flowchart of FIG. 8C.

In step S8330, for each of the M candidate learning models, the CPU 191 of the cloud server 12 performs “object detection processing that is processing of detecting, for each of the P captured images, an object from the captured image using the candidate learning model”. In this embodiment as well, the result of object detection processing for the captured image is the position information of the image region (the rectangular region or the detection region) of an object detected from the captured image.

In step S8331, the CPU 191 obtains a score for “the result of object detection processing for each of the P captured images” in correspondence with each of the M candidate learning models. The CPU 191 then performs ranking (ranking creation) of the M candidate learning models based on the scores, and selects N candidate learning models from the M candidate learning models. The score for the result of object detection processing by the candidate learning model is obtained by, for example, the following method.

For example, assume that in a task of detecting an abnormality on a printed board, object detection processing is executed for various kinds of specific local patterns on a fixed printed pattern. Here, by a specific learning model, detection regions 901 to 906 shown in FIG. 9A are assumed to be obtained from a captured image of a normal product. Since the occurrence frequency of abnormality in products manufactured in the manufacturing line is very low, a good learning model in executing the task is a learning model capable of outputting a stable result to assumed variations in captured images. For example, if the appearance of an image obtained by capturing a product slightly changes due to a variation in the environment on the area sensor side, it may be impossible to detect the detection region 906 of the detection regions 901 to 906, as shown in FIG. 9B. In this case, a penalty should be given to the evaluation score of a learning model that changes the detection region in response to an input including only a small difference.

Hence, for example, for each of the M candidate learning models, the CPU 191 of the cloud server 12 decides a score that becomes larger as the difference in the arrangement pattern of detection regions by the candidate learning model becomes larger between the P captured images. Such a score can be obtained by calculating, for example, equation (4) described above. The M candidate learning models are ranked in the ascending order of score, and N high-rank candidate learning models are selected in the ascending order of score. At the time of selection, a condition that “the score is less than a threshold” may be added.

In step S8332, for the P captured image, the CPU 131 of the information processing apparatus 13 performs scoring (display image scoring) for presenting information that facilitates comparison by the subjectivity of the user, as in the first embodiment (step S2332).

In step S8333, the CPU 131 of the information processing apparatus 13 causes the display apparatus 14 to display, for each of the N candidate learning models selected in step S8331, F high-rank captured images in the descending order of score in the P captured images received from the cloud server 12 and the results of object detection processing for the captured images received from the cloud server 12. At this time, the F captured images are arranged and displayed from the left side in the descending order of score.

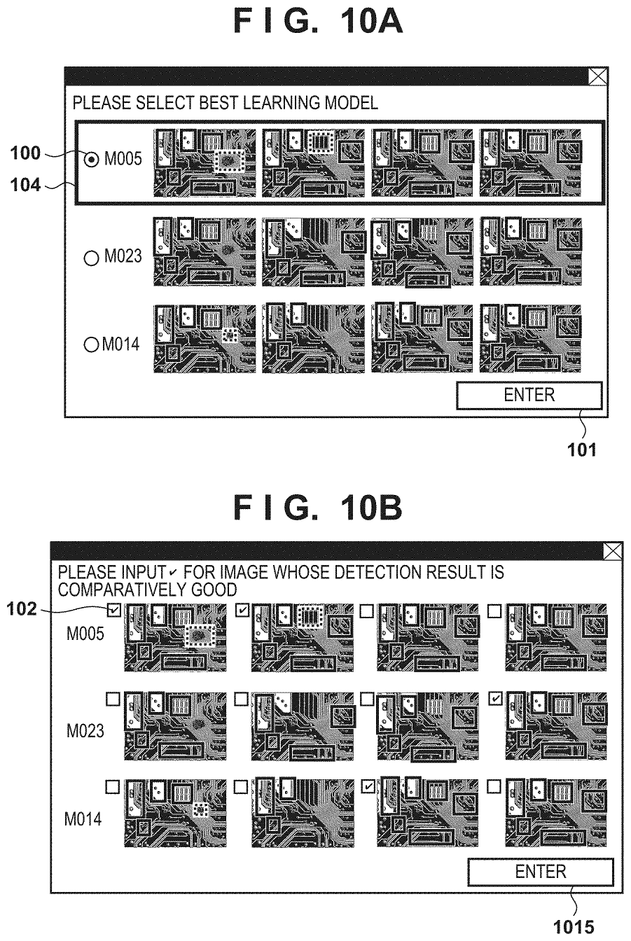

FIG. 10A shows a display example of a GUI that displays captured images and results of object detection processing for each candidate learning model. FIG. 10A shows a case in which N=3, and F=4.

In the uppermost row, the model name “M005” of the candidate learning model with the highest score is displayed together with a radio button 100. On the right side, four high-rank captured images are arranged and displayed sequentially from the left side in the descending order of score. Frames representing detection regions detected from the captured images by the candidate learning model of the model name “M005” are superimposed on the captured images.

In the row of the middle stage, the model name “M023” of the candidate learning model with the second highest score is displayed together with the radio button 100. On the right side, four high-rank captured images are arranged and displayed sequentially from the left side in the descending order of score. Frames representing the detection regions detected from the captured images by the candidate learning model of the model name “M023” are superimposed on the captured images.

In the row of the lower stage, the model name “M014” of the candidate learning model with the third highest score is displayed together with the radio button 100. On the right side, four high-rank captured images are arranged and displayed sequentially from the left side in the descending order of score. Frames representing the detection regions detected from the captured images by the candidate learning model of the model name “M014” are superimposed on the captured images.

Note that on this GUI, to allow the user to easily compare the results of object detection processing by the candidate learning models at a glance, display is done such that identical captured images are arranged on the same column.

In this case, as for the difference in the detection region arrangement pattern, since the product outer appearance is almost fixed, and many products are normal products in many cases, display as shown in FIG. 10A is performed. The F captured images are arranged and displayed sequentially in the descending order of score. The score tends to be high if the difference in the image capturing condition at the time of individual image capturing is large, or if an individual includes an abnormal region. Hence, as compared to the conventional method in which the user executes an annotation operation for abnormal regions in the captured images of products in advance, and manually searches for defective products from many products and then does settings of the inspection apparatus, since a captured image of a product that may include an abnormal region can be preferentially presented to the user only by seeing the GUI without executing the operation at all, labor can be saved. The user selects a learning model that can correctly detect an abnormal region by comparing the results of object detection processing on the GUI shown in FIG. 10A.

The user visually confirms the difference between the results of object detection processing for the F captured images by the N candidate learning models, and selects one of the N candidate learning models using the user interface 15.

In step S8334, the CPU 131 of the information processing apparatus 13 accepts the candidate learning model selection operation (user input) by the user. In step S8335, the CPU 131 of the information processing apparatus 13 judges whether the candidate learning model selection operation (user input) by the user is performed.

In the case shown in FIG. 10A, to select the candidate learning model of the model name “M005”, the user selects the radio button 100 on the uppermost row using the user interface 15. To select the candidate learning model of the model name “M023”, the user selects the radio button 100 on the row of the middle stage using the user interface 15. To select the candidate learning model of the model name “M014”, the user selects the radio button 100 on the row of the lower stage using the user interface 15. Since the radio button 100 corresponding to the model name “MOOS” is selected in FIG. 10A, a frame 104 indicating that the candidate learning model of the model name “MOOS” is selected is displayed.

When the user instructs a decision button 101 by operating the user interface 15, the CPU 131 judges that “the candidate learning model selection operation (user input) by the user is performed”, and selects the candidate learning model corresponding to the selected radio button 100 as a selected learning model.

As the result of judgment, if the candidate learning model selection operation (user input) by the user is performed, the process advances to step S8336. If the candidate learning model selection operation (user input) by the user is not performed, the process returns to step S8334.

In step S8336, the CPU 131 of the information processing apparatus 13 confirms whether it is a state in which learning models as many as “the number desired by the user” are finally selected. If it is a state in which learning models as many as “the number desired by the user” are finally selected, the process advances to step S84. If it is not a state in which learning models as many as “the number desired by the user” are finally selected, the process returns to step S8332.

Here, “the number desired by the user” is decided mainly in accordance with the time (tact time) that can be consumed for visual inspection. For example, if “the number desired by the user” is 2, a low-frequency abnormal region is detected by one learning model, and a high-frequency defect is detected by the other learning model. When the tendency of the detection target is changed in this way, broader detection may be possible.

If the user cannot narrow down the candidates to “the number desired by the user” only by seeing the display in FIG. 10A, a plurality of candidate learning models may be selected by selecting a plurality of radio buttons 100. For example, if “the number desired by the user” is “1”, and the number of selected radio buttons 100 is 2, N=2, and the process returns to step S8332 via step S8336. In this case, the same processing as described above is performed for N=2, and F=4 from step S8332. In this way, the processing is repeated until the number of finally selected learning models equals “the number desired by the user”.

Alternatively, the user may select a learning model using a GUI shown in FIG. 10B in place of the GUI shown in FIG. 10A. The GUI shown in FIG. 10A is a GUI configured to cause the user to directly select which learning model is appropriate. On the other hand, on the GUI shown in FIG. 10B, a check box 102 is provided on each captured image. For the captured images vertically arranged in each column, the user turns on (adds a check mark to) the check box 102 of a captured image judged to have a satisfactory result of object detection processing in the column of captured images by operating the user interface 15 to designate it. When the user instructs a decision button 1015 by operating the user interface 15, the CPU 131 of the information processing apparatus 13 selects, from the candidate learning models of the model names “MOOS”, “M023”, and “M014”, a candidate learning model in which the number of captured images whose check boxes 102 are ON is largest as a selected learning model. In the example shown in FIG. 10B, two check boxes 102 are ON in the four captured images of the candidate learning model whose model name is “M005”, the check box 102 is ON in one of the four captured images of the candidate learning model whose model name is “M023”, and the check box 102 is ON in one of the four captured images of the candidate learning model whose model name is “M014”. In this case, the candidate learning model of the model name “M005” is selected as the selected learning model. The selected learning model selection method using such a GUI is effective in a case in which, for example, the value F increases, and it is difficult for the user to judge which candidate learning model is best.

As the easiest method of finally narrowing down the candidates to learning models as many as “the number desired by the user” on the GUI shown in FIG. 10B, learning models are selected in the descending order of the number of check boxes in the ON state from the top up to the “the number desired by the user”.

Note that if candidate learning models in which “the numbers of captured images whose check boxes 102 are ON” are equal or slightly different exist, it is judged in step S8336 that “it is not a state in which learning models as many as “the number desired by the user” are finally selected”, and the process returns to step S8332. From step S8332, processing is performed for the candidate learning models in which “the numbers of captured images whose check boxes 102 are ON” are equal or slightly different. Even in this case, the processing is repeated until the number of finally selected learning models equals “the number desired by the user”.

Independently of the method used to select the selected learning model, the CPU 131 of the information processing apparatus 13 notifies the cloud server 12 of information representing the selected learning model (for example, the model name of the selected learning model).

In step S84, the CPU 191 of the cloud server 12 performs object detection processing for the captured image (the captured image transmitted from the camera 10 to the cloud server 12 and the information processing apparatus 13) using the selected learning model specified by the information notified from the information processing apparatus 13. The CPU 191 of the cloud server 12 performs final setting of the inspection apparatus based on the detection region obtained as the result of object detection processing. Inspection is executed when the manufacturing line is actually started up using the learning model set here and various kinds of parameters.

Note that the learning model according to this embodiment is a model learned by deep learning. However, various object detection techniques such as a detector, a fuzzy inference, or a genetic algorithm on a rule base defined by various kinds of parameters may be used as a learning model.

<Modifications>

Each of the above-described embodiments is an example of a technique for reducing the cost of performing learning of a learning model and adjusting settings every time detection/identification processing for new target is performed in a task of executing target detection/identification processing. Hence, the application target of the technique described in each of the above-described embodiments is not limited to prediction of the yield of a crop, repair region detection, and detection of an abnormal region in an industrial product as an inspection target. The technique is applied to agriculture, industry, fishing industry, and other broader fields.

The above-described radio button or check box is displayed as an example of a selection portion used by the user to select a target, and another display item may be displayed instead if it has a similar effect. Also, in the above-described embodiments, a configuration that selects a learning model to be used in object detection processing based on a user operation has been described (step S24). However, the present invention is not limited to this, and a learning model to be used in object detection processing may automatically be selected. For example, the candidate learning model of the highest score may automatically be selected as a learning model to be used in object detection processing.

In addition, the main constituent of each processing in the above description is merely an example. For example, a part or whole of processing described as processing to be performed by the CPU 191 of the cloud server 12 may be performed by the CPU 131 of the information processing apparatus 13. Also, a part or whole of processing described as processing to be performed by the CPU 131 of the information processing apparatus 13 may be performed by the CPU 191 of the cloud server 12.

In the above description, the system according to each embodiment performs analysis processing. However, the main constituent of analysis processing is not limited to the system according to the embodiment and, for example, another apparatus/system may perform the analysis processing.

### Third Embodiment

In this embodiment as well, a system having the configuration shown in FIG. 1 is used, as in the first embodiment.

A cloud server 12 will be described. In the cloud server 12, a captured image (a captured image to which Exif information is attached) transmitted from a camera 10 is registered. Also, a plurality of learning models (detectors/settings) to be used to detect (object detection) an image region concerning a crop (object) from the captured image are registered in the cloud server 12. The learning models are models learned under learning environments different from each other. The cloud server 12 selects, from the plurality of learning models held by itself, a relatively robust learning model from the viewpoint of detection accuracy when detecting an image region concerning a crop from the captured image. The cloud server 12 uses a captured image whose deviation of the detection result is relatively large between the selected learning models is used for additional learning of the selected learning model.

Note that a captured image output from the camera 10 may temporarily be stored in a memory of another apparatus and transferred from the memory to the cloud server 12 via a communication network 11.

An information processing apparatus 13 will be described next. The information processing apparatus 13 is a computer apparatus such as a PC (personal computer), a smartphone, or a tablet terminal apparatus. The information processing apparatus 13 accepts an annotation operation for a captured image specified by the cloud server 12 as “a captured image that needs an adding operation (annotation operation) of supervised data (GT: Ground Truth)) representing a correct answer”. The cloud server 12 performs additional learning of “a relatively robust learning model from the viewpoint of detection accuracy when detecting an image region concerning a crop from the captured image” using a plurality of captured images including the captured image that has undergone the annotation operation by the user, thereby updating the learning model. The cloud server 12 detects the image region concerning the crop from the captured image by the camera 10 using the learning models held by itself, thereby performing the above-described analysis processing.

When such an annotation operation is executed for a number of (for example, several hundred to several thousand) captured images every time a farm field is captured, it takes a very high cost (for example, time cost or labor cost). In this embodiment, captured images as the target of the annotation operation are narrowed down, thereby reducing the cost concerning the annotation operation.

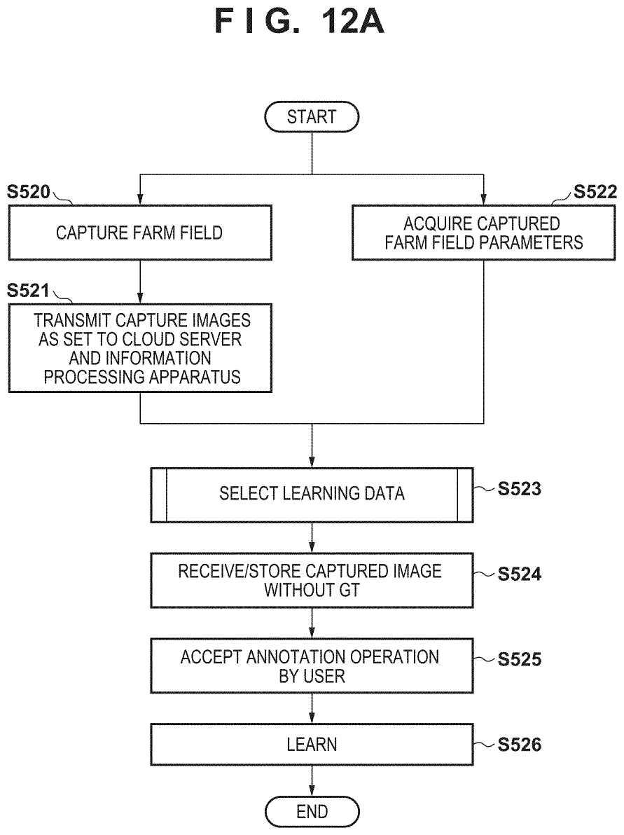

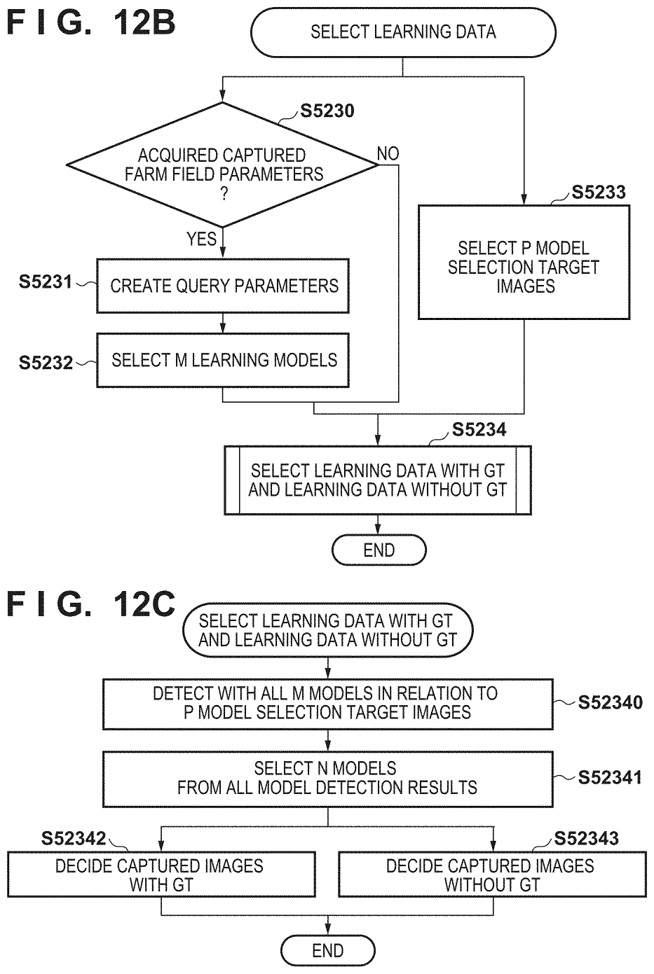

A series of processes of specifying a captured image that needs the annotation operation, accepting the annotation operation for the captured image, and performing additional learning of a learning model using the captured image that has undergone the annotation operation will be described with reference to the flowchart of FIG. 12A. In this additional learning, additional learning can be performed using a relatively small number of captured images as compared to a case in which the learning is performed using captured images of a farm field selected at random. It is therefore possible to obtain a satisfactory prediction result while suppressing the cost of the cumbersome manual annotation operation as low as possible.

In step S520, the camera 10 captures a farm field during movement of a moving body such as a tractor 32 for agricultural work or a drone 37, thereby generating captured images of the farm field, as in step S20 described above.

In step S521, the camera 10 attaches Exif information to the captured images generated in step S520, and transmits the captured images with the Exif information to the cloud server 12 and the information processing apparatus 13 via the communication network 11, as in step S21 described above.

In step S522, a CPU 131 of the information processing apparatus 13 acquires information concerning the farm field captured by the camera 10, the crop, and the like (the cultivar of the crop, the age of trees, the growing method and the pruning method of the crop, and the like) as captured farm field parameters, as in step S22 described above.

Note that the processing of step S522 is not essential because even if the captured farm field parameters are not acquired in step S522, selection of candidate learning models using the captured farm field parameters to be described later need only be omitted. The captured farm field parameters need not be acquired if, for example, the information concerning the farm field or the crop (the cultivar of the crop, the age of trees, the growing method and the pruning method of the crop, and the like) is unknown. Note that if the captured farm field parameters are not acquired, N candidate learning models are selected not from “M selected candidate learning models” but from “all learning models” in the subsequent processing.

In step S523, processing for selecting a captured image that is learning data to be used for additional learning of a learning model is performed. Details of the processing in step S523 will be described with reference to the flowchart of FIG. 12B.

In step S5230, the CPU 191 of the cloud server 12 judges whether the captured farm field parameters are acquired from the information processing apparatus 13. As the result of judgment, if the captured farm field parameters are acquired from the information processing apparatus 13, the process advances to step S5231. If the captured farm field parameters are not acquired from the information processing apparatus 13, the process advances to step S5234.

In step S5231, the CPU 191 of the cloud server 12 generates a query parameter based on Exif information attached to each captured image acquired from the camera 10 and the captured farm field parameters (the captured farm field parameters of a section corresponding to the captured images) acquired from the information processing apparatus 13 and registered in an external storage device 196.

Next, in step S5232, the CPU 191 of the cloud server 12 selects (narrows down) M (1≤M<E) learning models (candidate learning models) that are candidates in E (E is an integer of 2 or more) learning models stored in the external storage device 196, as in step S231 described above. In the selection, learning models that have learned based on an environment similar to the environment represented by the query parameter are selected as the candidate learning models. A parameter set representing what kind of environment was used by a learning model for learning is stored in the external storage device 196 for each of the E learning models.

Note that the smaller the value of a similarity D obtained by equations (1) to (3) is, “the higher the similarity is”. The larger the value of the similarity D obtained by equations (1) to (3) is, “the lower the similarity is”.

On the other hand, in step S5233, the CPU 191 of the cloud server 12 selects, as model selection target images, P (P is an integer of 2 or more) captured images from the captured images received from the camera 10, as in step S232 described above.

In step S5234, captured images with GT (learning data with GT) and captured images without GT (learning data without GT) are selected using the M candidate learning models selected in step S5232 (or all learning models) and the P captured images selected in step S5233.

A captured image with GT (learning data with GT) is a captured image in which detection of an image region concerning a crop is relatively correctly performed. A captured image without GT (learning data without GT) is a captured image in which detection of an image region concerning a crop is not so correctly performed. Details of the processing in step S5234 will be described with reference to the flowchart of FIG. 12C.

In step S52340, for each of the M candidate learning models, the CPU 191 of the cloud server 12 performs “object detection processing that is processing of detecting, for each of the P captured images, an object from the captured image using the candidate learning model”, as in step S2330 described above.

In step S52341, the CPU 191 obtains a score for “the result of object detection processing for each of the P captured images” in correspondence with each of the M candidate learning models, as in step S2331 described above. The CPU 191 then performs ranking (ranking creation) of the M candidate learning models based on the scores, and selects N (N M) candidate learning models from the M candidate learning models.

At this time, since the captured images have no label (annotation information), correct detection accuracy evaluation cannot be done. However, in a target that is intentionally designed and maintained, like a farm, the accuracy of object detection processing can be predicted and evaluated using the following rules. A score for the result of object detection processing by a candidate learning model is obtained, for example, in the following way.

The N candidate learning models selected from the M candidate learning models (to be simply referred to as “N candidate learning models” hereinafter) are learning models that have learned based on captured images in an image capturing environment similar to the image capturing environment of the captured images acquired in step S520. That is, the N candidate learning models are learning models that have learned based on an environment similar to the environment represented by the query parameter. The N candidate learning models are relatively robust learning models from the viewpoint of detection accuracy when detecting an image region concerning a crop from the captured images.

Hence, in step S52342, the CPU 191 acquires, as “captured images with GT”, captured images used for the learning of the N candidate learning models from the captured image group stored in the external storage device 196.

In the above steps, the learning models are narrowed down by predetermined scoring. In most cases, the results of object detection by the learning models selected in the step are similar results. In some cases, however, object detection results are often greatly different. For example, for captured images corresponding to a learned event common to many learning models or captured images corresponding to a case that is so simple that any learning model cannot make a mistake, almost the same detection results are obtained in all the N candidate learning models. However, for a case that hardly occurs in the captured images learned so far, a phenomenon that the object detection results by the learning models are different is observed.

Hence, in step S52343, the CPU 191 decides captured images corresponding to an important event as an event that has been learned little as captured images to be additionally learned. More specifically, in step S52343, the information of different portions in the object detection results by the N candidate learning models is evaluated, thereby deciding the priority of a captured image to be additionally learned. An example of the decision method will be described here.

In step S52343, for each of the P captured images, the CPU 191 decides a score that becomes larger as the difference in the arrangement pattern of detection regions becomes larger between the N candidate learning models. Such a score can be obtained by calculating, for example, equation (4) described above.

Then, the CPU 191 specifies, as a captured image with GT (learning data with GT), a captured image for which a score (a score obtained in accordance with equation (4)) less than a threshold is obtained in the P captured images.

On the other hand, the CPU 191 specifies, as “a captured image that needs the annotation operation” (a captured image without GT (learning data without GT)), a captured image for which a score (a score obtained in accordance with equation (4)) equal to or more than a threshold is obtained in the P captured images. The CPU 191 transmits the captured image (captured image without GT) specified as “a captured image that needs the annotation operation” to the information processing apparatus 13.

In step S524, the CPU 131 of the information processing apparatus 13 receives the captured image without GT transmitted from the cloud server 12 and stores the received captured image without GT in a RAM 132. Note that the CPU 131 of the information processing apparatus 13 may display the captured image without GT received from the cloud server 12 on a display apparatus 14 and present the captured image without GT to the user.

In step S525, since the user of the information processing apparatus 13 performs the annotation operation for the captured image without GT received for the cloud server 12 by operating a user interface 15, the CPU 131 accepts the annotation operation. When the CPU 131 adds, to the captured image without GT, a label input by the annotation operation for the captured image without GT, the captured image without GT changes to a captured image with GT.

Here, not only the captured image without GT received from the cloud server 12 but also, for example, a captured image specified in the following way may be specified as a target for which the user performs the annotation operation.

The CPU 191 of the cloud server 12 specifies Q (Q<P) captured images from the top in the descending order of score (the score obtained in accordance with equation (4)) from the P captured images (or another captured image group). The CPU 191 then transmits, to the information processing apparatus 13, the Q captured images, the scores of the Q captured images, “the results of object detection processing for the Q captured images” corresponding to each of the N candidate learning models, information (a model name and the like) concerning the N candidate learning models, and the like. As described above, in this embodiment, “the result of object detection processing for a captured image” is the position information of the image region (the rectangular region or the detection region) of an object detected from the captured image. Such position information is transmitted to the information processing apparatus 13 as, for example, data in a file format such as the j son format or the txt format.

For each of the N candidate learning models, the CPU 131 of the information processing apparatus 13 causes the display apparatus 14 to display the Q captured images received from the cloud server 12 and the results of object detection processing for the captured images, which are received from the cloud server 12. At this time, the Q captured images are arranged and displayed from the left side in the descending order of score.

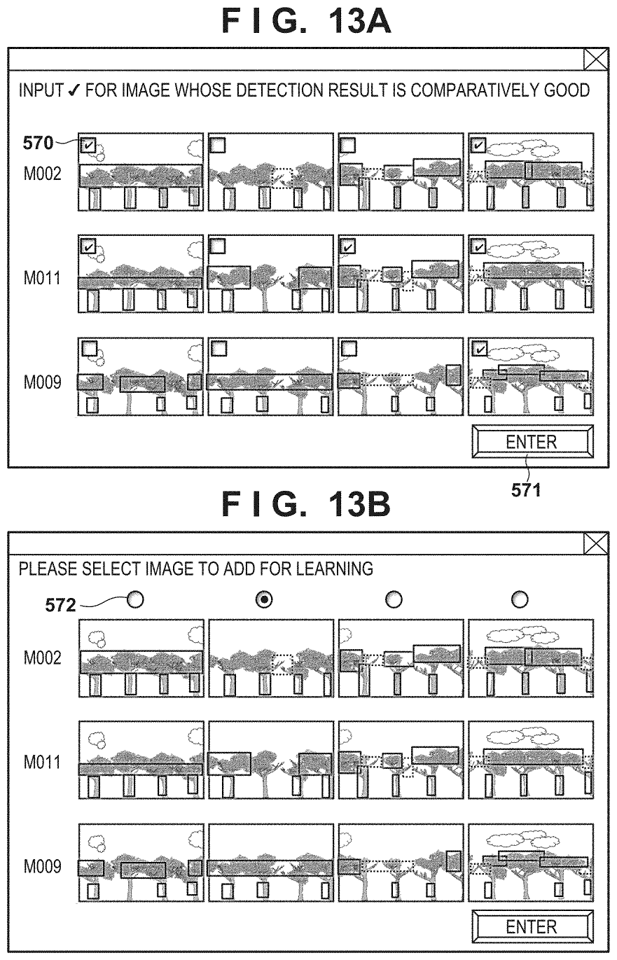

FIG. 13A shows a display example of a GUI that displays captured images and results of object detection processing for each candidate learning model. FIG. 13A shows a case in which N=3, and Q=4.

In the uppermost row, the model name “M002” of the candidate learning model with the highest score is displayed. On the right side, four high-rank captured images are arranged and displayed sequentially from the left side in the descending order of score together with a check box 570. Frames representing the detection regions of objects detected from the captured images by the candidate learning model of the model name “M002” are superimposed on the captured images.

In the row of the middle stage, the model name “M011” of the candidate learning model with the second highest score is displayed. On the right side, four high-rank captured images are arranged and displayed sequentially from the left side in the descending order of score together with the check box 570. Frames representing the detection regions of objects detected from the captured images by the candidate learning model of the model name “M011” are superimposed on the captured images.

In the row of the lower stage, the model name “M009” of the candidate learning model with the third highest score is displayed. On the right side, four high-rank captured images are arranged and displayed sequentially from the left side in the descending order of score together with a check box 570. Frames representing the detection regions of objects detected from the captured images by the candidate learning model of the model name “M009” are superimposed on the captured images.

Note that on this GUI, to allow the user to easily compare the results of object detection processing by the candidate learning models at a glance, display is done such that identical captured images are arranged on the same column.

In the example shown in FIG. 13A, in additional learning later, the three candidate learning models use the captured images used for the learning of the three candidate learning models, which have undergone the annotation operation. Then, “captured images that are likely to express an event not learned by the captured images that have undergone the annotation operation”, which are used additionally, are specified.

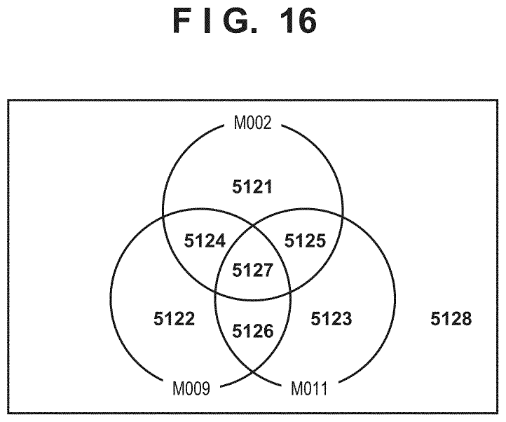

The relationship between a set of captured images and the result of object detection processing by three candidate learning models for each captured image belonging to the set will be described here with reference to the Venn diagram of FIG. 16. In the Venn diagram of FIG. 16, the quality of each of the results of object detection processing by the three candidate learning models (the model names are “M002”, “M009”, and “M011”) is expressed as a binary value. The inside of each of a circle corresponding to “M002”, a circle corresponding to “M009”, and a circle corresponding to “M011” represents a set of captured images in which correct results of object detection processing are obtained. In addition, the outside of each of the circle corresponding to “M002”, the circle corresponding to “M009”, and the circle corresponding to “M011” represents a set of captured images in which wrong results of object detection processing are obtained.

The set of captured images included in a region S127, that is, the set of captured images in which correct results of object detection processing are obtained in all the three candidate learning models is considered to have already been learned by the three candidate learning models. Hence, the captured images are not worth being added to the target of additional learning.

The set of captured images included in a region 5128, that is, the set of captured images in which wrong results of object detection processing are obtained in all the three candidate learning models is considered to include captured images not learned by the candidate learning models or captured image expressing an insufficiently learned event. Hence, the captured images included in the region 5128 are likely captured images that should actively be added to the target of additional learning.

The captured images displayed on the GUI shown in FIG. 13A are likely to include not only the captured images corresponding to the region 5128 but also captured images in which correct results of object detection processing are obtained only by the candidate learning model of the model name “M002” (captured images included in a region S121), captured images in which correct results of object detection processing are obtained only by the candidate learning model of the model name “M009” (captured images included in a region S122), and captured images in which correct results of object detection processing are obtained only by the candidate learning model of the model name “M011” (captured images included in a region 5123). In addition, there is a possibility that captured images corresponding to regions 5124, 5125, and 5126 are also included in the captured images displayed on the GUI shown in FIG. 13A depending on the difference in the detection region arrangement pattern.

Hence, a system that does not know a true correct answer displays a captured image decided based on a score (a score based on the difference between the results of object detection processing) obtained simply in accordance with equation (4) as “a candidate for a captured image to be additionally learned”. Hence, a short captured image that is not included in the learned captured images yet needs to be decided by teaching of the user.

Hence, the CPU 131 of the information processing apparatus 13 accepts a designation operation of a captured image as a target of the annotation operation” by the user. In the case of FIG. 13A, the user confirms the results of object detection processing by the candidate learning model of the model name “M002”, the candidate learning model of the model name “M011”, and the candidate learning model of the model name “M009”. The user turns on (adds a check mark to) the check box 570 of a captured image judged to have a satisfactory result of object detection processing by operating the user interface 15 to designate it.

In the example shown in FIG. 13A, in the captured images on the first column from the left side, the check boxes 570 of the captured images of the upper and middle stages are ON. In the captured images on the second column from the left side, the check boxes 570 are not ON in any of the captured images. In the captured images on the third column from the left side, the check box 570 of the captured image of the middle stage is ON. In the captured images on the fourth column from the left side, the check boxes 570 of all the captured images are ON.

When the user instructs a decision button 571 by operating the user interface 15, the CPU 131 of the information processing apparatus 13 counts the number of captured images with check marks for each column of captured images. The CPU 131 of the information processing apparatus 13 specifies a captured image corresponding to a column where the score based on the counted number is equal to or more than a threshold as “a captured image to be additionally learned (a captured image for which the annotation operation should be performed for the purpose)”.

As for a captured image corresponding to a column without a check mark, since the result of object detection processing is “failure” in all the three candidate learning models, the captured image is judged as a captured image included in the region 5128 and selected as a captured image whose degree of importance of additional learning is high.

On the other hand, a captured image corresponding to a column with check marks in all check boxes is selected as a captured image whose degree of importance of additional learning is low because the result of object detection processing is “success” in all the three candidate learning models.

In many cases, a captured image for which similar results of object detection processing are obtained by all candidate learning models based on the scores obtained by equation (4) should not be displayed on the GUI above. However, if the detection region arrangement patterns are different but have the same meaning, or if the detection region arrangement patterns are different depending on the use case, but both cases are correct, the check boxes 570 of all captured images in a vertical column may be turned on. Hence, on the GUI, for a captured image on a column with a small number of check marks, a score that increases the degree of importance of additional learning is obtained, and captured images as the target of the annotation operation are specified from the Q captured images based on the score. Such a score can be obtained in accordance with, for example,

$$Score ( {I}_{z} ) = {{w}_{z} ( N - {C}_{{I}_{2}} )}^{2} , {w}_{z} ∝ Score ( z )$$

wherein Score(I_{z}) is the score for a captured image I_{z}, C_{I}_{_{z}} is the number of captured images whose check boxes 570 are ON in the column of the captured image I_{z} (the number of check marks in the column), and w_{z} is a weight value proportional to the score of the captured image I_{z} obtained in accordance with equation (4).

The CPU 131 of the information processing apparatus 13 specifies a captured image for which the score obtained by equation (5) is equal to or more than a threshold in the Q captured images as “a captured image as the target of the annotation operation”. For example, a captured image corresponding to a column without a check mark may be specified as “a captured image as the target of the annotation operation”. In this way, if “a captured image as the target of the annotation operation” is specified by operating the GUI shown in FIG. 13A, the user of the information processing apparatus 13 performs the annotation operation for “the captured image as the target of the annotation operation” by operating the user interface 15. Hence, in step S525, the CPU 131 accepts the annotation operation, and adds, to the captured image, a label input by the annotation operation for the captured image.

Also, the result of object detection processing displayed on the GUI shown in FIG. 13A for the captured image whose check box 570 is ON may be used as the label to the captured image, and the captured image with the label may be included in the target of additional learning.

Note that for a user who understands the criterion for specifying “the captured image as the target of the annotation operation”, directly selecting “the captured image as the target of the annotation operation” may facilitate the input operation. In this case, “the captured image as the target of the annotation operation” may be specified in accordance with a user operation via a GUI shown in FIG. 13B.

On the GUI shown in FIG. 13B, a radio button 572 is provided for each column of captured images. When the user turns on the radio button 572 corresponding to the first column from the left side by operating the user interface 15, each captured image corresponding to the column is specified as “a captured image as the target of the annotation operation”. When the user turns on the radio button 572 corresponding to the second column from the left side by operating the user interface 15, each captured image corresponding to the column is specified as “a captured image as the target of the annotation operation”. When the user turns on the radio button 572 corresponding to the third column from the left side by operating the user interface 15, each captured image corresponding to the column is specified as “a captured image as the target of the annotation operation”. When the user turns on the radio button 572 corresponding to the fourth column from the left side by operating the user interface 15, each captured image corresponding to the column is specified as “a captured image as the target of the annotation operation”.

When specifying “a captured image as the target of the annotation operation” using such a GUI, the radio button 572 corresponding to a captured image in which a mistake is readily made in detecting an object is turned on.

If “a captured image as the target of the annotation operation” is specified as described above by operating the GUI shown in FIG. 13B, the user of the information processing apparatus 13 performs the annotation operation for “the captured image as the target of the annotation operation” by operating the user interface 15. Hence, in step S525, the CPU 131 accepts the annotation operation, and adds, to the captured image, a label input by the annotation operation for the captured image.

The CPU 131 of the information processing apparatus 13 then transmits the captured image (captured image with GT) that has undergone the annotation operation by the user to the cloud server 12.

In step S526, the CPU 191 of the cloud server 12 performs additional learning of the N candidate learning models using the captured images (captured images with GT) to which the labels are added in step S525 and “the captured images (captured images with GT) used for the learning of the N candidate learning models” which are acquired in step S52342. The CPU 191 of the cloud server 12 stores the N candidate learning models that have undergone the additional learning in the external storage device 196 again.

An example of the learning and inference method used here, a region-based CNN technique such as Fater RCNN is used. In this method, learning is possible if rectangular coordinates and the sets of label annotation information and images used in this embodiment are provided.

As described above, according to this embodiment, even if images captured in an unknown farm field are input, detection of a nonproductive region and the like can accurately be executed on a captured image basis. In particular, when a ratio obtained by subtracting the ratio of a nonproductive region estimated by this method is integrated on the yield in a case in which a harvest of 100% can be obtained per unit area, the yield of a crop to be harvested from the target farm field can be predicted.

To set a region where the width of a rectangular region detected as a nonproductive region exceeds a predetermined value defined by the user to a repair target, a target image is specified based on the width of the detected rectangular region, and where the tree of the repair target exists on the map is presented to the user based on the Exif information and the like of the target image.

### Fourth Embodiment

From this embodiment, the difference from the third embodiment will be described, and the remaining is assumed to be the same as in the third embodiment unless it is specifically stated otherwise below. In this embodiment, a system that performs visual inspection in a production line of a factory will be described as an example. The system according to this embodiment detects an abnormal region of an industrial product that is an inspection target.

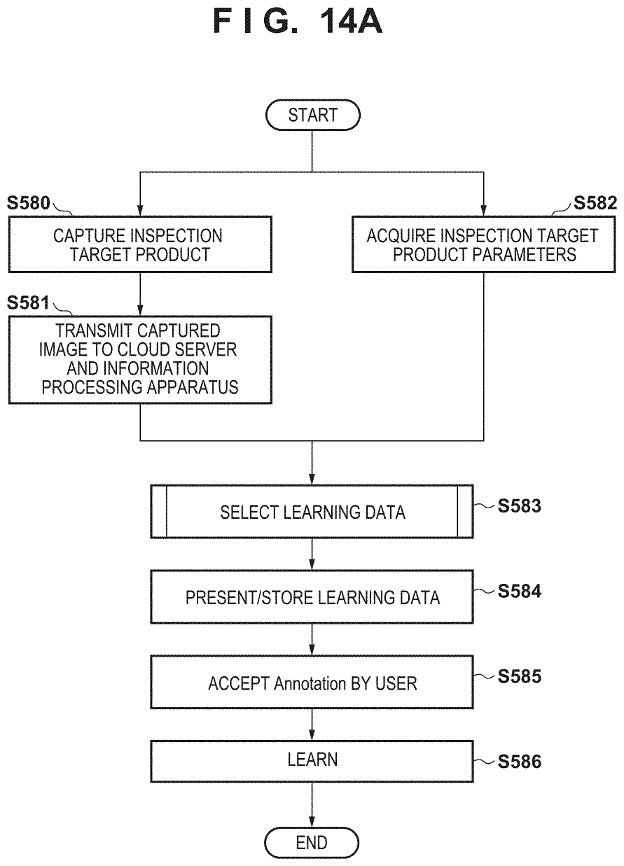

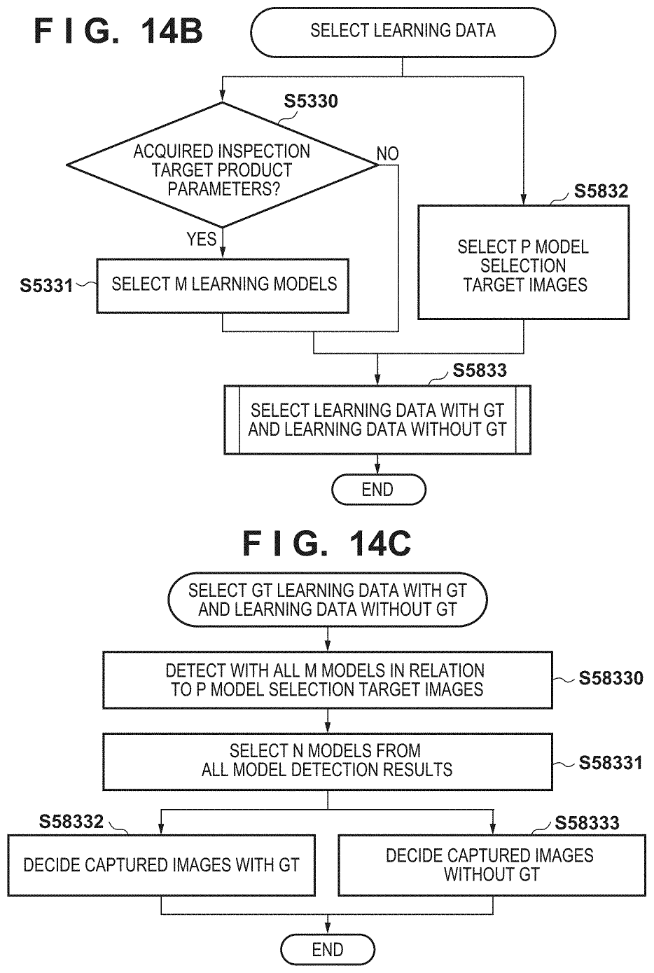

Inspection apparatus setting processing (setting processing for visual inspection) by the system according to this embodiment will be described with reference to the flowchart of FIG. 14A. Note that the setting processing for visual inspection is assumed to be executed at the time of startup of an inspection step in a manufacturing line.

In step S580, a camera 10 captures the inspection target product, thereby generating a captured image of the inspection target product. In step S581, the camera 10 transmits the captured image generated in step S580 to a cloud server 12 and an information processing apparatus 13 via a communication network 11.

In step S582, a CPU 131 of the information processing apparatus 13 acquires, as inspection target product parameters, information (the part name and the material of the inspection target product, the manufacturing date, image capturing system parameters in image capturing, the lot number, the atmospheric temperature, the humidity, and the like) concerning the inspection target product and the like captured by the camera 10, as in step S82 described above. For example, the CPU 131 causes a display apparatus 14 to display a GUI and accepts input of inspection target product parameters from the user. When the user inputs a registration instruction by operating a user interface 15, the CPU 131 of the information processing apparatus 13 transmits, to the cloud server 12, the inspection target product parameters of the above-described items input on the GUI. A CPU 191 of the cloud server 12 stores (registers), in the external storage device 196, the inspection target product parameters transmitted from the information processing apparatus 13.

Note that the processing of step S582 is not essential because even if the inspection target product parameters are not acquired in step S582, selection of candidate learning models using the captured farm field parameters to be described later need only be omitted. The inspection target product parameters need not be acquired if, for example, the information (the part name and the material of the inspection target product, the manufacturing date, image capturing system parameters in image capturing, the lot number, the atmospheric temperature, the humidity, and the like) concerning the inspection target product and the like captured by the camera 10 is unknown. Note that if the inspection target product parameters are not acquired, N candidate learning models are selected not from “M selected candidate learning models” but from “all learning models” in the subsequent processing.

In step S583, processing for selecting a captured image to be used for learning of a learning model is performed. Details of the processing in step S583 will be described with reference to the flowchart of FIG. 14B.

In step S5830, the CPU 191 of the cloud server 12 judges whether the inspection target product parameters are acquired from the information processing apparatus 13. As the result of judgment, if the inspection target product parameters are acquired from the information processing apparatus 13, the process advances to step S5831. If the inspection target product parameters are not acquired from the information processing apparatus 13, the process advances to step S5833.

In step S5831, the CPU 191 of the cloud server 12 selects M learning models (candidate learning models) as candidates from E learning models stored in the external storage device 196. The CPU 191 generates a query parameter from the inspection target product parameters registered in the external storage device 196 and the Exif information, as in the third embodiment, and selects learning models that have learned in an environment similar to the environment indicated by the query parameter (learning models used in similar inspection in the past).

In step S5831 as well, M candidate learning models are selected using the parameter sets of learning models and the query parameter, as in the third embodiment. At this time, equation (1) described above is used in as in the third embodiment.

Next, in step S5832, the CPU 191 of the cloud server 12 selects P captured images from the captured images received from the camera 10. For example, products transferred to the inspection step of the manufacturing line are selected at random, and P captured images are acquired from images captured by the camera 10 under the same settings as in the actual operation. The number of abnormal products that occur in the manufacturing line is normally small. For this reason, if the number of products captured in the step is small, processing in the subsequent steps does not function well. Hence, at least almost several hundred products are preferably captured.

In step S5833, captured images with GT (learning data with GT) and captured images without GT (learning data without GT) are selected using the M candidate learning models selected in step S5831 (or all learning models) and the P captured images selected in step S5832.

A captured image with GT (learning data with GT) according to this embodiment is a captured image in which detection of an abnormal region or the like of an industrial product as an inspection target is relatively correctly performed. A captured image without GT (learning data without GT) is a captured image in which detection of an abnormal region of an industrial product as an inspection target is not so correctly performed. Details of the processing in step S5833 will be described with reference to the flowchart of FIG. 14C.

In step S58330, for each of the M candidate learning models, the CPU 191 of the cloud server 12 performs “object detection processing that is processing of detecting, for each of the P captured images, an object from the captured image using the candidate learning model”, as in step S8330 described above. In this embodiment as well, the result of object detection processing for a captured image is the position information of the image region (the rectangular region or the detection region) of an object detected from the captured image.

In step S58331, the CPU 191 obtains a score for “the result of object detection processing for each of the P captured images” in correspondence with each of the M candidate learning models, as in step S8331 described above. The CPU 191 then performs ranking (ranking creation) of the M candidate learning models based on the scores, and selects N (N M) candidate learning models from the M candidate learning models.

In step S58332, the CPU 191 acquires, as “captured images with GT”, captured images used for the learning of the N candidate learning models from the captured image group stored in the external storage device 196.

In step S58333, captured images corresponding to an important event as an event that has been learned little are decided as captured images to be additionally learned. More specifically, in step S58333, the information of different portions in the object detection results by the N candidate learning models is evaluated, thereby deciding the priority of a captured image to be additionally learned. An example of the decision method will be described here.

In step S58333, the CPU 191 specifies, as a captured image with GT (learning data with GT), a captured image for which a score (a score obtained in accordance with equation (4)) less than a threshold is obtained in the P captured images, as in step S52343 described above.

On the other hand, the CPU 191 specifies, as “a captured image that needs the annotation operation” (a captured image without GT (learning data without GT)), a captured image for which a score (a score obtained in accordance with equation (4)) equal to or more than a threshold is obtained in the P captured images. The CPU 191 transmits the captured image (captured image without GT) specified as “a captured image that needs the annotation operation” to the information processing apparatus 13.

In step S584, the CPU 131 of the information processing apparatus 13 receives the captured image without GT transmitted from the cloud server 12 and stores the received captured image without GT in a RAM 132.

In step S585, since the user of the information processing apparatus 13 performs the annotation operation for the captured image without GT received for the cloud server 12 by operating a user interface 15, the CPU 131 accepts the annotation operation. When the CPU 131 adds, to the captured image without GT, a label input by the annotation operation for the captured image without GT, the captured image without GT changes to a captured image with GT.

Here, not only the captured image without GT received from the cloud server 12 but also, for example, a captured image specified in the following way may be specified as a target for which the user performs the annotation operation.

The CPU 191 of the cloud server 12 specifies Q (Q<P) high-rank captured images in the descending order of score (the score obtained in accordance with equation (4)) from the P captured images (or another captured image group). The CPU 191 then transmits, to the information processing apparatus 13, the Q captured images, the scores of the Q captured images, “the results of object detection processing for the Q captured images” corresponding to each of the N candidate learning models, information (a model name and the like) concerning the N candidate learning models, and the like.

For each of the N candidate learning models, the CPU 131 of the information processing apparatus 13 causes the display apparatus 14 to display the Q captured images received from the cloud server 12 and the results of object detection processing for the captured images, which are received from the cloud server 12. At this time, the Q captured images are arranged and displayed from the left side in the descending order of score.

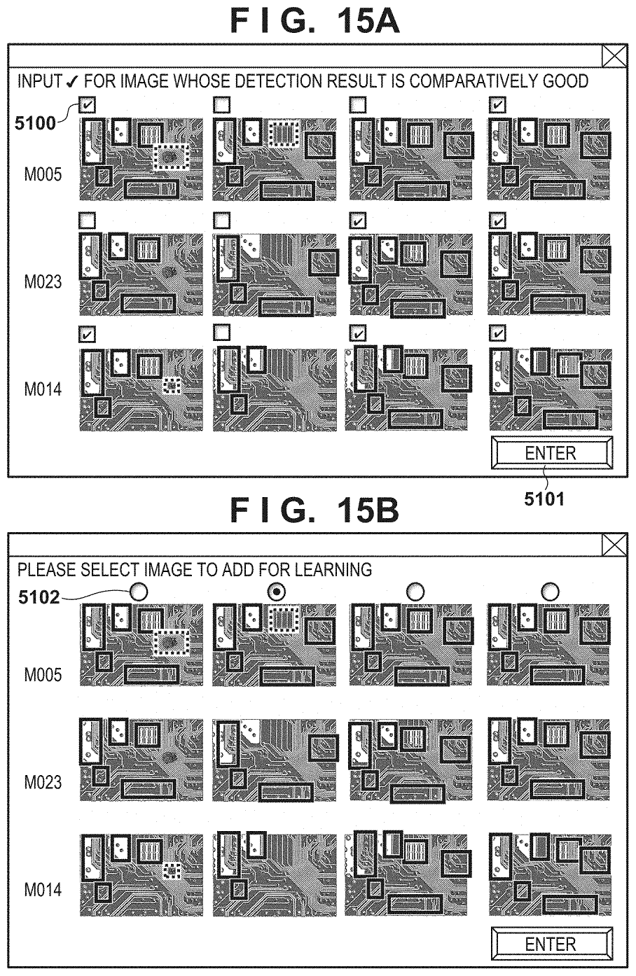

FIG. 15A shows a display example of a GUI that displays captured images and results of object detection processing for each candidate learning model. FIG. 15A shows a case in which N=3, and Q=4.

In the uppermost row, the model name “M005” of the candidate learning model with the highest score is displayed. On the right side, four high-rank captured images are arranged and displayed sequentially from the left side in the descending order of score together with a check box 5100. Frames representing the detection regions of objects detected from the captured images by the candidate learning model of the model name “M005” are superimposed on the captured images.

In the row of the middle stage, the model name “M023” of the candidate learning model with the second highest score is displayed. On the right side, four high-rank captured images are arranged and displayed sequentially from the left side in the descending order of score together with the check box 5100. Frames representing the detection regions of objects detected from the captured images by the candidate learning model of the model name “M023” are superimposed on the captured images.

In the row of the lower stage, the model name “M014” of the candidate learning model with the third highest score is displayed. On the right side, four high-rank captured images are arranged and displayed sequentially from the left side in the descending order of score together with a check box 5100. Frames representing the detection regions of objects detected from the captured images by the candidate learning model of the model name “M014” are superimposed on the captured images.

Note that on this GUI, to allow the user to easily compare the results of object detection processing by the candidate learning models at a glance, display is done such that identical captured images are arranged on the same column. The user turns on (adds a check mark to) the check box 5100 of a captured image judged to have a satisfactory result of object detection processing by operating the user interface 15 to designate it.

When the user instructs a decision button 5101 by operating the user interface 15, the CPU 131 of the information processing apparatus 13 counts the number of captured images with check marks for each column of captured images. The CPU 131 of the information processing apparatus 13 specifies a captured image corresponding to a column where the score based on the counted number is equal to or more than a threshold as “a captured image to be additionally learned (a captured image for which the annotation operation should be performed for the purpose)”. As described above, the series of processes for specifying “a captured image for which the annotation operation should be performed” is the same as in the third embodiment.

In this way, if “a captured image as the target of the annotation operation” is specified by operating the GUI shown in FIG. 15A, the user of the information processing apparatus 13 performs the annotation operation for “the captured image as the target of the annotation operation” by operating the user interface 15. Hence, in step S585, the CPU 131 accepts the annotation operation, and adds, to the captured image, a label input by the annotation operation for the captured image.

Also, the result of object detection processing displayed on the GUI shown in FIG. 15A for the captured image whose check box 5100 is ON may be used as the label to the captured image, and the captured image with the label may be included in the target of additional learning.

Note that for a user who understands the criterion for specifying “the captured image as the target of the annotation operation”, directly selecting “the captured image as the target of the annotation operation” may facilitate the input operation. In this case, “the captured image as the target of the annotation operation” may be specified in accordance with a user operation via a GUI shown in FIG. 15B.

The method of designating “a captured image for which the annotation operation should be performed” using the GUI shown in FIG. 15B is the same as the method of designating “a captured image for which the annotation operation should be performed” using the GUI shown in FIG. 13B, and a description thereof will be omitted.

The CPU 131 of the information processing apparatus 13 then transmits the captured image (captured image with GT) that has undergone the annotation operation by the user to the cloud server 12.

In step S586, the CPU 191 of the cloud server 12 performs additional learning of the N candidate learning models using the captured images (captured images with GT) to which the labels are added in step S585 and “the captured images (captured images with GT) used for the learning of the N candidate learning models” which are acquired in step S58332. The CPU 191 of the cloud server 12 stores the N candidate learning models that have undergone the additional learning in the external storage device 196 again.

<Modifications>

Each of the above-described embodiments is an example of a technique for reducing the cost of performing learning of a learning model and adjusting settings every time detection/identification processing for new target is performed in a task of executing target detection/identification processing. Hence, the application target of the technique described in each of the above-described embodiments is not limited to prediction of the yield of a crop, repair region detection, and detection of an abnormal region in an industrial product as an inspection target. The technique is applied to agriculture, industry, fishing industry, and other broader fields.

The above-described radio button or check box is displayed as an example of a selection portion used by the user to select a target, and another display item may be displayed instead if it can implement a similar function.

In addition, the main constituent of each processing in the above description is merely an example. For example, a part or whole of processing described as processing to be performed by the CPU 191 of the cloud server 12 may be performed by the CPU 131 of the information processing apparatus 13. Also, a part or whole of processing described as processing to be performed by the CPU 131 of the information processing apparatus 13 may be performed by the CPU 191 of the cloud server 12.

In the above description, the system according to each embodiment performs analysis processing. However, the main constituent of analysis processing is not limited to the system according to the embodiment and, for example, another apparatus/system may perform the analysis processing.

The above-described various kinds of functions described above as the functions of the cloud server 12 may be executed by the information processing apparatus 13. In this case, the system may not include the cloud server 12. In addition, the learning model acquisition method is not limited to a specific acquisition method. Also, various object detectors may be applied in place of a learning model.

### Fifth Embodiment

In recent years, along with the development of image analysis techniques and various kinds of recognition techniques, various kinds of so-called image recognition techniques for enabling detection or recognition of an object captured as a subject in an image have been proposed. Particularly in recent years, there has been proposed a recognition technique for enabling detection or recognition of a predetermined target captured as a subject in an image using a recognizer (to be also referred to as a “model” hereinafter) constructed based on so-called machine learning. WO 2018/142766 discloses a method of performing, using a plurality of models, detection in several images input as test data and presenting the information and the degree of recommendation of each model based on the detection result, thereby selecting a model to be finally used.

On the other hand, in the agriculture field, a technique of performing processing concerning detection of a predetermined target region for an image of a crop captured by an image capturing device mounted on a vehicle, thereby enabling to grasp a disease, growth state of the crop and the situation of the farm field has been examined.

In the conventional technique, under a situation in which images input as test data include very few target regions as the detection target, the degree of recommendation does not change between the plurality of models, and it may be difficult to decide which one of the plurality of models should be selected. For example, consider the above-described case in which processing concerning detection of a predetermined target region is performed for an image captured by an image capturing device mounted on a vehicle in the agriculture field. In this case, the vehicle does not necessarily capture only a place where the crop can be captured, and the image capturing device mounted on the vehicle may capture an image that does not include the crop. If such an image including no crop is used as test data to the plurality of models, the target region cannot be detected by any model, and it is impossible to judge which model should be selected.

However, in the technique described in WO 2018/142766, when selecting one of the plurality of models, selecting test data that causes a difference in the detection result is not taken into consideration.

In consideration of the above-described problem, this embodiment provides a technique for enabling to appropriately select a model according to a detection target from a plurality of models constructed based on machine learning.

<Outline>

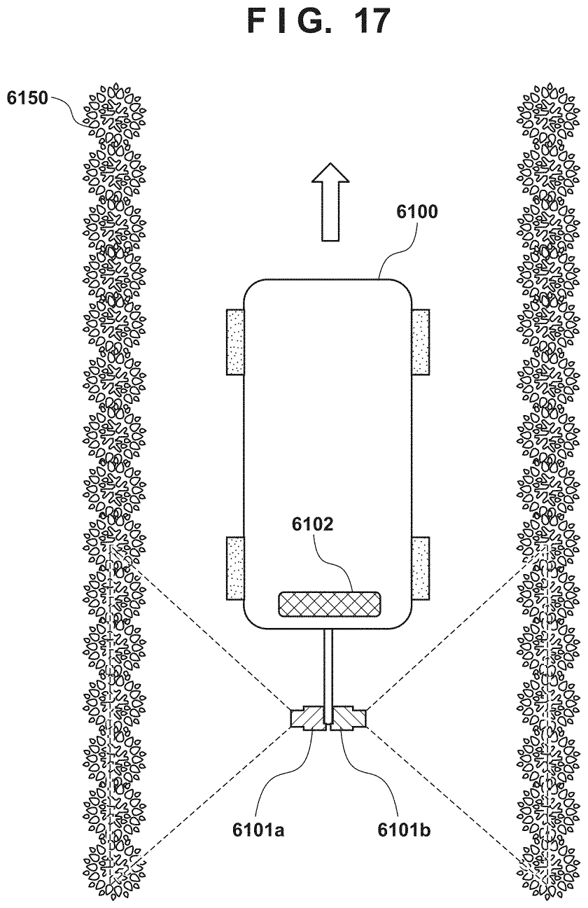

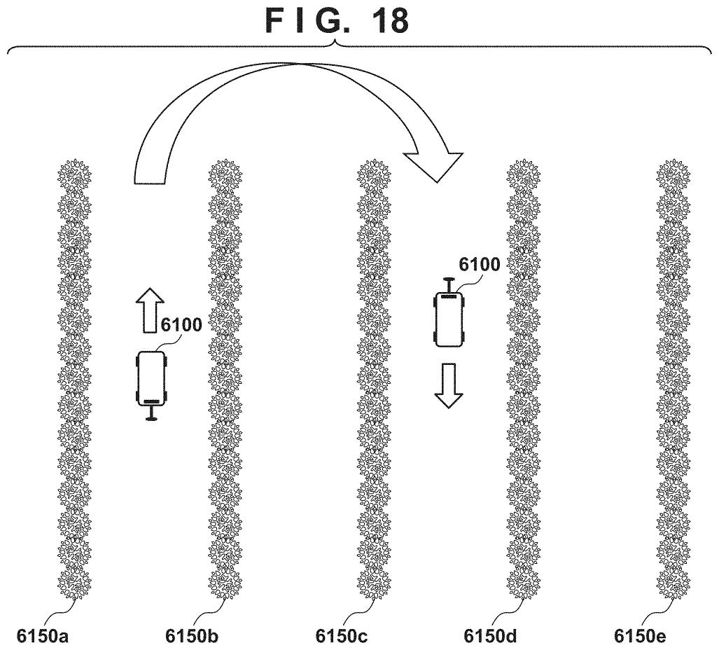

The outline of an information processing system according to an embodiment of the present invention will be described with reference to FIGS. 17 and 18. Note that the technique will be described while placing focus on a case in which the technique is applied to management of a farm field in the agriculture field such that the features of the technique according to this embodiment can be understood better.

Generally, in cultivating wine grapes, management tends to be done by dividing a farm field into sections for each cultivar or tree age of grape trees, and in many cases, trees planted in each section are of the same cultivar or same tree age. Also, in a section, cultivation is often done such that fruit trees are planted to form a row of fence, and a plurality of rows of fruit trees are formed.

Under this assumption, for example, in the example shown in FIG. 17, image capturing devices 6101a and 6101b are supported by a vehicle 6100 such that regions on the left and right sides of the vehicle 6100 can be captured. Also, the operation of each of the image capturing devices 6101a and 6101b is controlled by a control device 6102 mounted on the vehicle 6100. In this configuration, for example, while the vehicle 6100 is traveling between fences 6150 of fruit trees in a direction in which the fences 6150 extend, the image capturing devices 6101a and 6101b capture still images or moving images. Note that if “still image” and “moving image” need not particularly be discriminated, these will sometimes simply be referred to as “image” in the following description. In other words, if “image” is used, both “still image” and “moving image” can be applied unless restrictions are particularly present.

FIG. 18 schematically shows a state in which the vehicle 6100 travels every other passage formed between two fences 6150. More specifically, the vehicle 6100 travels through the passage between fences 6150a and 6150b and then through the passage between fences 6150c and 6150d. Hence, each of the fruit trees forming the series of fences 6150 (for example, the fences 6150a to 6150e) is captured at least once by the image capturing device 6101a or 6101b.

In the above-described way, various kinds of image recognition processing are applied to images according to the image capturing results of the series of fruit trees (for example, wine grape trees), thereby managing the states of the fruit trees using the result of the image recognition processing. As a detailed example, a model whose detection target is a dead branch is applied to an image according to an image capturing result of a fruit tree. If an abnormality has occurred in the fruit tree, the abnormality can be detected. As another example, when a model that detects a visual feature that becomes apparent due to a predetermined disease is applied, a fruit tree in which the disease has occurred can be detected. When a model that detects fruit (for example, a bunch of grapes) is applied, a fruit detection result from an image according to an image capturing result can be used to manage the state of the fruit.

<Hardware Configuration>

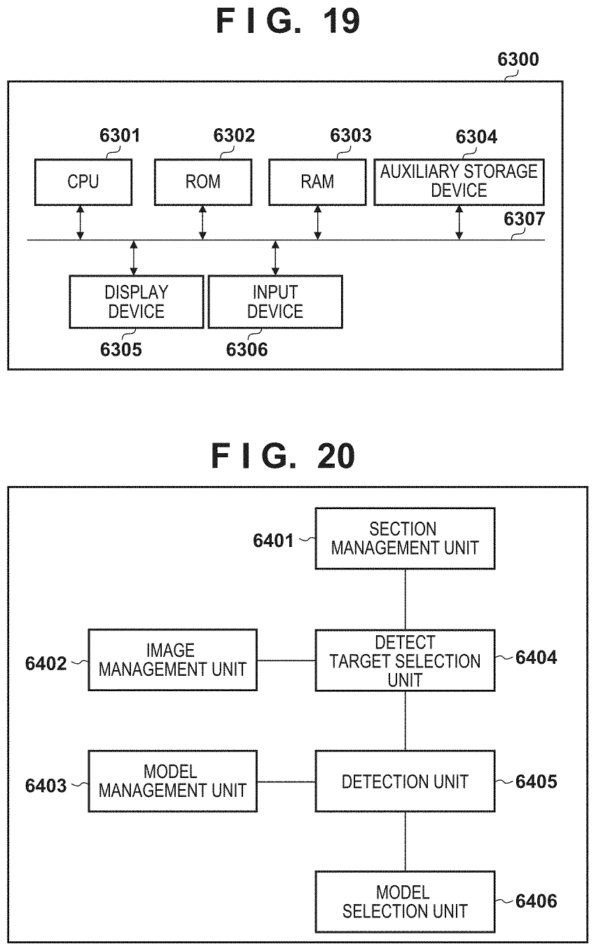

An example of the hardware configuration of an information processing apparatus applied to the information processing system according to an embodiment of the present invention will be described with reference to FIG. 19.

An information processing apparatus 6300 includes a CPU (Central Processing Unit) 6301, a ROM (Read Only Memory) 6302, a RAM (Random Access Memory) 6303, and an auxiliary storage device 6304. In addition, the information processing apparatus 6300 may include at least one of a display device 6305 and an input device 6306. The CPU 6301, the ROM 6302, the RAM 6303, the auxiliary storage device 6304, the display device 6305, and the input device 6306 are connected to each other via a bus 6307.

The CPU 6301 is a central processing unit that controls various kinds of operations of the information processing apparatus 6300. For example, the CPU 6301 controls the operations of various kinds of constituent elements connected to the bus 6307.

The ROM 6302 is a storage area that stores various kinds of programs and various kinds of data, like a so-called program memory. The ROM 6302 stores, for example, a program used by the CPU 6301 to control the operation of the information processing apparatus 6300.

The RAM 6303 is the main storage memory of the CPU 6301 and is used as a work area or a temporary storage area used to load various kinds of programs.

The CPU 6301 reads out a program stored in the ROM 6302 and executes it, thereby implementing processing according to each flowchart to be described later. Also, a program memory may be implemented by loading a program stored in the ROM 6302 into the RAM 6303. The CPU 6301 may store information according to the execution result of each processing in the RAM 6303.

The auxiliary storage device 6304 is a storage area that stores various kinds of data and various kinds of programs. The auxiliary storage device 6304 may be configured as a nonvolatile storage area. The auxiliary storage device 6304 can be implemented by, for example, a medium (recording medium) and an external storage drive configured to implement access to the medium. As such a medium, for example, a flash memory, a USB memory, an SSD (Solid State Drive) memory, an HDD (Hard Disk Drive), a flexible disk (FD), a CD-ROM, a DVD, an SD card, or the like can be used. Also, the auxiliary storage device 6304 may be a device (for example, a server) connected via a network. In addition, the auxiliary storage device 6304 may be implemented as a storage area (for example, an SSD) incorporated in the CPU 6301.

In the following description, for the descriptive convenience, assume that an SSD incorporated in the information processing apparatus 6300 and an SD card used to receive data from the outside are applied as the auxiliary storage device 6304. Note that a program memory may be implemented by loading a program stored in the auxiliary storage device 6304 into the RAM 6303. The CPU 6301 may store information according to the execution result of various kinds of processing in the auxiliary storage device 6304.

The display device 6305 is implemented by, for example, a display device represented by a liquid crystal display or an organic EL display, and presents, to a user, information as an output target as visually recognizable display information such as an image, a character, or a graphic. Note that the display device 6305 may be externally attached to the information processing apparatus 6300 as an external device.

The input device 6306 is implemented by, for example, a touch panel, a button, or a pointing device (for example, a mouse) and accepts various kinds of operations from the user. In addition, the input device 6306 may be implemented by a pressure touch panel, an electrostatic touch panel, a write pen, or the like disposed in the display region of the display device 6305, and accept various kinds of operations from the user for a part of the display region. Note that the input device 6306 may be externally attached to the information processing apparatus 6300 as an external device.

<Functional Configuration>

An example of the functional configuration of the information processing apparatus according to an embodiment of the present invention will be described with reference to FIG. 20. The information processing apparatus according to this embodiment includes a section management unit 6401, an image management unit 6402, a model management unit 6403, a detection target selection unit 6404, a detection unit 6405, and a model selection unit 6406.

Note that the function of each constituent element shown in FIG. 20 is implemented when, for example, the CPU 6301 loads a program stored in the ROM 6302 into the RAM 6303 and executes it. In addition, if hardware is formed as an alternative to software processing using the CPU 6301, a calculation unit or circuit corresponding to the processing of each constituent element to be described below is configured.

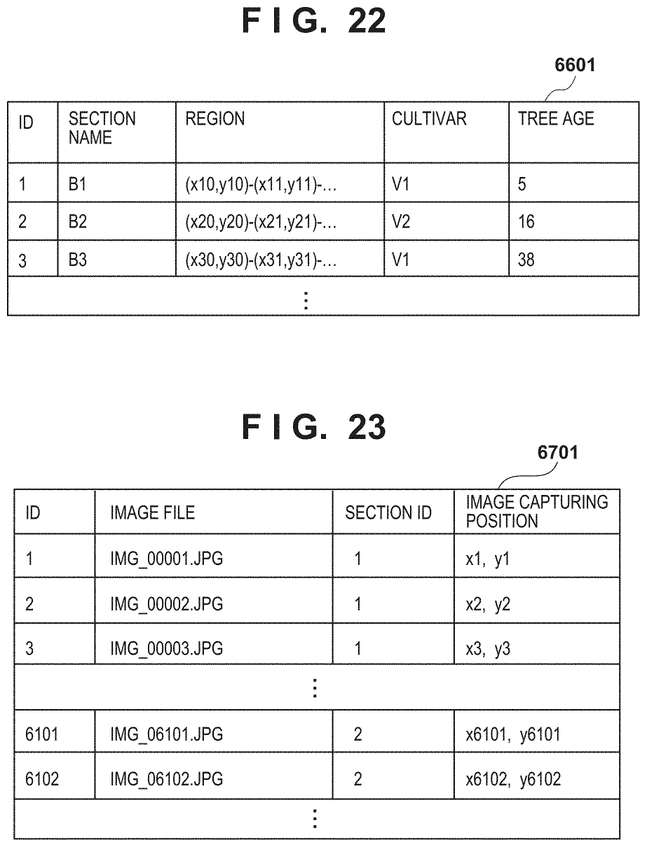

The section management unit 6401 manages each of a plurality of sections formed by dividing a management target region in association with the attribute information of the section. As a detailed example, the section management unit 6401 may manage each section of a farm field in association with information (in other words, the attribute information of the section) concerning the section. Note that the section management unit 6401 may store data concerning management of each section in a predetermined storage area (for example, the auxiliary storage device 6304 or the like) and manage the data. Also, an example of a management table concerning management of sections will separately be described later with reference to FIG. 22.

The image management unit 6402 manages various kinds of image data. As a detailed example, the image management unit 6402 may manage image data acquired from the outside via the auxiliary storage device 6304 or the like. An example of such image data is the data of images according to image capturing results by the image capturing devices 6101a and 6101b. Note that the image management unit 6402 may store various kinds of data in a predetermined storage area (for example, the auxiliary storage device 6304 or the like) and manage the data. Image data as the management target may be managed in a file format. Image data managed in a file format will also be referred to as an “image file” in the following description. An example of a management table concerning management of image data will separately be described later with reference to FIG. 23.

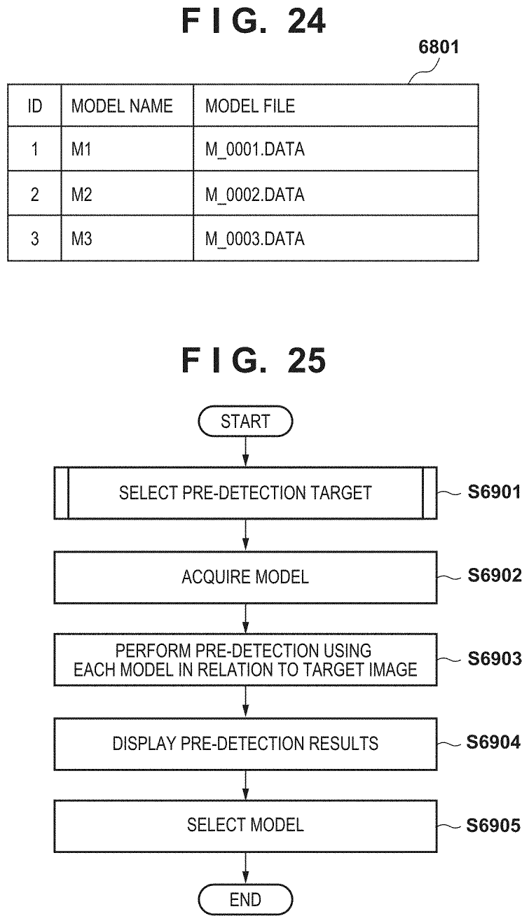

The model management unit 6403 manages a plurality of models constructed in advance based on machine learning to detect a predetermined target (for example, a target captured as a subject in an image) in an image. As a detailed example, as at least some of the plurality of models managed by the model management unit 6403, models constructed based on machine learning to detect a dead branch from an image may be included. Note that the model management unit 6403 may store the data of various kinds of models in a predetermined storage area (for example, the auxiliary storage device 6304 or the like) and manage the data. An example of a management table concerning management of models will separately be described later with reference to FIG. 24. In addition, each of the plurality of models managed by the model management unit 6403 may be learned by different learning data. For example, the plurality of models managed by the model management unit 6403 may be learned by learning data of different cultivars. Also, the plurality of models managed by the model management unit 6403 may be learned by learning data of different tree ages.

The detection target selection unit 6404 selects at least some images of a series of images (for example, a series of images obtained by capturing a section) associated with the designated section. As a detailed example, the detection target selection unit 6404 may accept a designation of at least some sections of a series of sections obtained by dividing a farm field and select at least some of images according to the image capturing result of the section.

The detection unit 6405 applies a model managed by the model management unit 6403 to an image selected by the detection target selection unit 6404, thereby detecting a predetermined target in the images. As a detailed example, the detection unit 6405 may apply a model constructed based on machine learning to detect a dead branch to a selected image of a section of a farm field, thereby detecting a dead branch captured as a subject in the image.

The model selection unit 6406 presents information according to the detection result of a predetermined target from an image by the detection unit 6405 to the user via the display device 6305. Then, in accordance with an instruction from the user via the input device 6306, the model selection unit 6406 selects a model to be used to detect the predetermined target from images in subsequent processing from the series of models managed by the model management unit 6403. The model selection unit 6406 outputs the result of detection processing obtained by applying a model managed by the model management unit 6403 to an image selected by the detection target selection unit 6404.

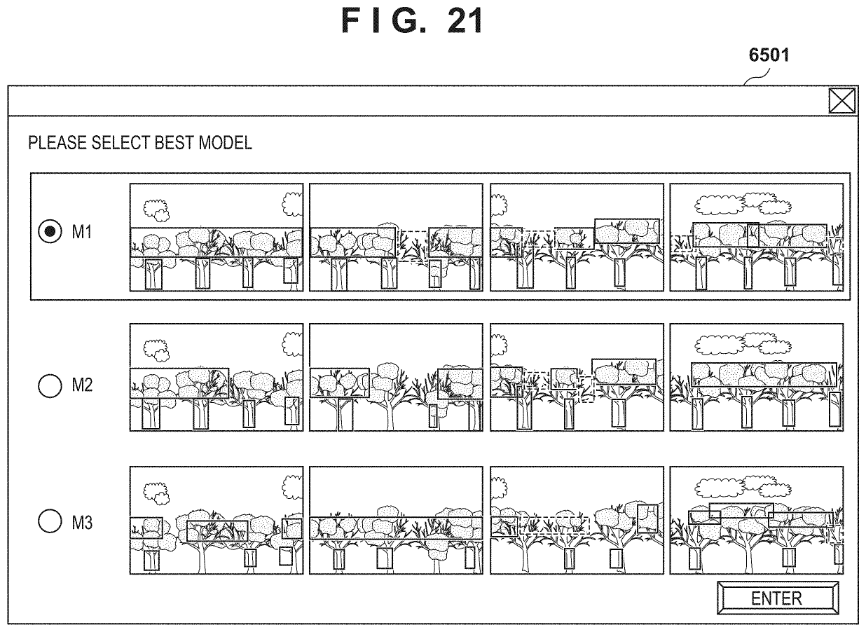

For example, FIG. 21 shows an example of a screen configured to present the detection result of a predetermined target from an image by the detection unit 6405 to the user and accept an instruction concerning model selection from the user. More specifically, on a screen 6501, information according to the application result of each of models M1 to M3 to images selected by the detection target selection unit 6404 (that is, information according to the detection result of a predetermined target from the images) is displayed on a model basis. Also, the screen 6501 is configured to be able to accept, by a radio button, an instruction about selection of one of the models M1 to M3 from the user.

The model selected by the model selection unit 6406 is, for example, a model applied to a series of images associated with a section to detect a predetermined target (for example, a dead branch or the like) from the images.

As described above, the information processing apparatus according to this embodiment applies a plurality of models to at least some of a series of images associated with a desired section, thereby detecting a predetermined target. Then, in accordance with the application results of the plurality of models to the selected images, the information processing apparatus selects at least some of the plurality of models as models to be used to detect the target from the series of images associated with the section.

In the following description, for the descriptive convenience, detection of a predetermined target from an image, which is performed by the detection unit 6405 for model selection, will also be referred to as “pre-detection”, and detection of the target from an image using a selected model will also be referred to as “actual detection”.

Note that the functional configuration shown in FIG. 20 is merely an example, and the functional configuration of the information processing apparatus according to this embodiment is not limited if the functions can be implemented by executing the processing of the above-described constituent elements. For example, the functional configuration shown in FIG. 20 may be implemented by cooperation of a plurality of apparatuses. As a detailed example, some constituent elements (for example, at least one of the section management unit 6401, the image management unit 6402, and the model management unit 6403) of the constituent elements shown in FIG. 20 may be provided in another apparatus. As another example, the load of processing of at least some of the constituent elements shown in FIG. 20 may be distributed to a plurality of apparatuses.

<Management Tables>

Examples of management tables used by the information processing apparatus according to this embodiment to manage various kinds of information will be described with reference to FIGS. 22 to 24 while placing focus particularly on the management of sections, images, and models.

FIG. 22 shows an example of a section management table used by the section management unit 6401 to manage each of a plurality of sections obtained by dividing a region of a target. More specifically, a section management table 6601 shown in FIG. 22 shows an example of a management table used to manage each of a plurality of sections, which are obtained by dividing a farm field, based on the cultivar of grape trees planted in the section and the tree age of the grape trees.

The section management table 6601 includes information about the ID of a section, a section name, and the region of a section as attribute information concerning each section. The ID of a section and the section name are used as information for identifying each section. The information about the region of a section is information representing the geographic form of a section. As the information about the region of a section, for example, information about the position and area of a region occupied as a section can be applied. Also, in the example shown in FIG. 22, the section management table 6601 includes, as attribute information concerning a section, information about the cultivar of grape trees planted in the section and the tree age of the grape trees (In other words, information about a crop planted in the section).

FIG. 23 shows an example of an image management table used by the image management unit 6402 to manage image data. More specifically, an image management table 6701 shown in FIG. 23 shows an example of a management table used to manage, on a section basis, image data according to the image capturing result of each of a plurality of sections obtained by dividing a farm field. Note that in the example shown in FIG. 23, image data are managed in a file format.

The image management table 6701 includes, as attribute information concerning an image, the ID of an image, an image file, the ID of a section, and an image capturing position. The ID of an image is used as information for identifying each image data. The image file is information for specifying image data managed as a file, and, for example, the file name of an image file or the like can be used. The ID of a section is identification information for specifying a section associated with image data as a target (in other words, a section captured as a subject), and the ID of a section in the section management table 6601 is used. The image capturing position is information about the position where an image as a target is captured (in other words, the position of an image capturing device upon image capturing). The image capturing position may be specified based on, for example, a radio wave transmitted from a GPS (Global Positioning System) satellite, and information for specifying a position, like a latitude/longitude, is used.

FIG. 24 shows an example of a model management table used by the model management unit 6403 to manage models constructed based on machine learning. Note that in the example shown in FIG. 24, data of models are managed in a file format.

A model management table 6801 includes, as attribute information concerning a model, the ID of a model, a model name, and information about a model file. The ID of a model and the model name are used as information for identifying each model. The model file is information for specifying data of a model managed as a file, and, for example, the file name of the file of a model or the like can be used.

<Processing>

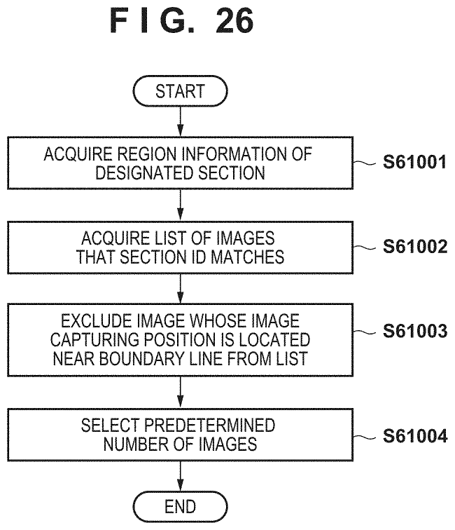

An example of processing of the information processing apparatus according to this embodiment will be described with reference to FIGS. 25 and 26.

FIG. 25 will be described first. FIG. 25 is a flowchart showing an example of processing concerning model selection by the information processing apparatus.

In step S6901, the detection target selection unit 6404 selects an image as a target of pre-detection by processing to be described later with reference to FIG. 26.

In step S6902, the detection unit 6405 acquires, from the model management unit 6403, information about a series of models concerning detection of a predetermined target.

In step S6903, the detection unit 6405 applies the series of models whose information is acquired in step S6902 to the image selected in step S6901, thereby performing pre-detection of the predetermined target from the image. Note that here, the detection unit 6405 applies each model to the image of each section obtained by dividing a farm field, thereby detecting a dead branch captured as a subject in the image.

In step S6904, the model selection unit 6406 presents information according to the result of pre-detection of the predetermined target (dead branch) from the image in step S6903 to the user via a predetermined output device (for example, the display device 6305).

In step S6905, the model selection unit 6406 selects a model to be used for actual detection of the predetermined target (dead branch) in accordance with an instruction from the user via a predetermined input device (for example, the input device 6306).

FIG. 26 will be described next. FIG. 26 is a flowchart showing an example of processing of the detection target selection unit 6404 to select an image to be used for pre-detection of a predetermined target from a series of images associated with a section divided from a target region. The series of processes shown in FIG. 26 corresponds to the processing of step S6901 in FIG. 25.

In step S61001, the detection target selection unit 6404 acquires the region information of the designated section from the section management table 6601. Note that the section designation method is not particularly limited. As a detailed example, a section as a target may be designated by the user via a predetermined input device (for example, the input device 6306 or the like). As another example, a section as a target may be designated in accordance with an execution result of a desired program.

In step S61002, the detection target selection unit 6404 acquires, from the image management table 6701, a list of images associated with the ID of the section designated in step S61001.

In step S61003, for each image included in the list acquired in step S61002, the detection target selection unit 6404 determines whether the image capturing position is located near the boundary of the section designated in step S61001. Then, the detection target selection unit 6404 excludes a series of images whose image capturing position is determined to be located near the boundary of the section from the list acquired in step S61002.

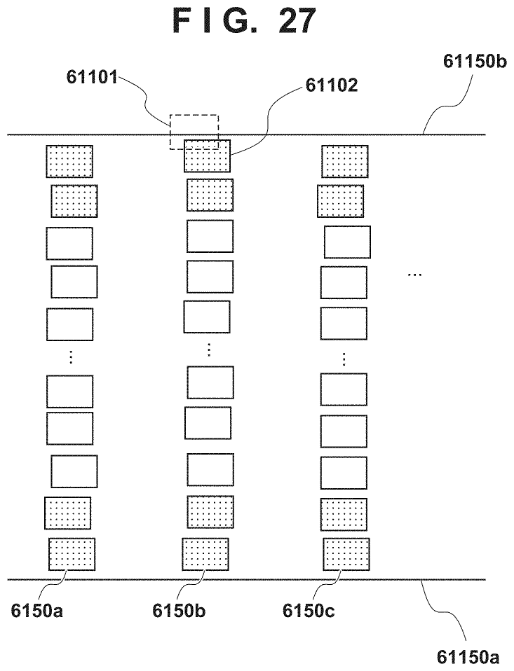

For example, FIG. 27 is a view showing an example of the correspondence relationship between an image capturing position and the boundary of a section. More specifically, FIG. 27 schematically shows a state in which an image in a target section is associated with each fence 6150 (for example, each of the fences 6150a to 6150c) based on the image capturing position of each image.

Note that when the image capturing position of an image is specified based on a radio wave transmitted from a satellite of a GPS, a slight deviation from the actual position may occur. For example, in FIG. 27, reference numeral 61101 schematically indicates an image capturing position where image capturing is actually performed. On the other hand, reference numeral 61102 schematically indicates an image capturing position specified in a state in which a deviation has occurred. In this case, an image corresponding to the image capturing position 61102 may include, as a subject, not a grape tree as a detection target but a road, a fence, or the like, which is not a detection target.

Considering such a situation, in the example shown in FIG. 27, of the series of images associated with the fences 6150, the detection target selection unit 6404 excludes, from the list, two images whose image capturing positions are closer to boundary lines (in other words, two images whose image capturing positions are located on the side of each end of the fences 6150). That is, based on at least one of the attribute information of a section in which a crop that is an image capturing target exists and the attribute information of a plurality of images associated with the section, the information processing apparatus 6300 determines an image in which the image capturing target or the detection target is not included from the plurality of images.

In step S61004, the detection target selection unit 6404 selects a predetermined number of images as the target of pre-detection from a series of images remaining in the list after the images are excluded from the list in step S61003. Note that the method of selecting images from the list in step S61004 is not particularly limited. For example, the detection target selection unit 6404 may select a predetermined number of images from the list at random. That is, in a case in which pre-detection of a dead branch region that is the detection target in a crop that is the image capturing target is performed, when selecting an image to be input to a plurality of models, the information processing apparatus 6300 limits selecting, as the target of pre-detection, an image determined not to include the crop as the image capturing target or the dead branch region as the detection target.

When control as described above is applied, for example, an image in which, as a subject, an object such as a road or a fence different from a grape tree is captured as the detection target can be excluded from the target of pre-detection. This increases the possibility that an image in which a grape tree as the detection target is captured as a subject is selected as the target of pre-detection. For this reason, for example, when selecting a model based on the result of pre-detection, a model more suitable to detect a dead branch can be selected. That is, according to the information processing apparatus of this embodiment, a more suitable model can be selected in accordance with the detection target from a plurality of models constructed based on machine learning.

<Modifications>

Modifications of this embodiment will be described below.

(Modification 1)

Modification 1 will be described below. In the above embodiment, a method has been described in which, based on information about the region of a section, which is the attribute information of the section, the detection target selection unit 6404 selects an image as a target of pre-detection by excluding an image in which an object such as a road or a fence other than a detection target is captured.

As is apparent from the contents described in the above embodiment, images as the target of pre-detection preferably include images in which an object such as a dead branch as the detection target is captured. When the number of images as the target of pre-detection is increased, the possibility that images in which an object such as a dead branch as the detection target is captured are included becomes high. On the other hand, the processing amount when applying a plurality of models to the images may increase, and the wait time until model selection is enabled may become long.

In this modification, an example of a mechanism will be described, which is configured to suppress an increase in the processing amount when applying models to images and enable selection of images that are more preferable as the target of pre-detection by controlling the number of images as the target of pre-detection or the number of models to be used based on the attribute information of a section.

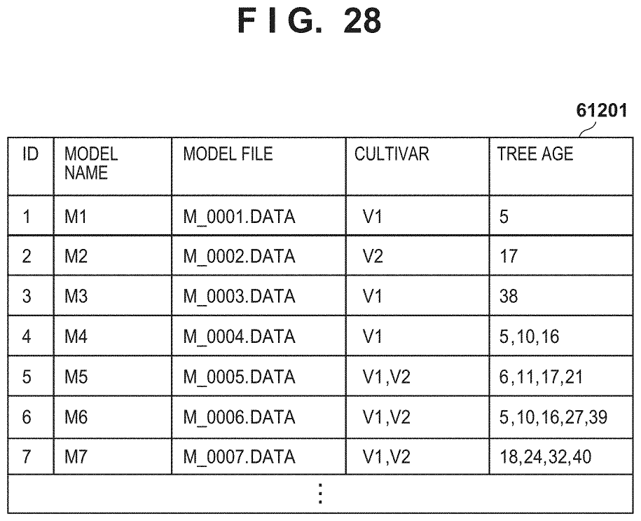

For example, FIG. 28 shows an example of a model management table used by the model management unit 6403 to manage models constructed based on machine learning. A model management table 61201 shown in FIG. 28 is different from the model management table 6801 shown in FIG. 24 in that information about an object that is a detection target for a target model is included as attribute information. More specifically, in the example shown in FIG. 28, the model management table 61201 includes, as information about a grape tree that is a detection target, information about the cultivar of the grape tree and information about the tree age of the grape tree.

In general, the detection accuracy tends to become high when a model constructed based on machine learning using data closer to data as the detection target is used. Considering the characteristic, in the example shown in FIG. 28, the information about the cultivar or tree age of the grape tree is managed in association with a model, thereby selectively using a model in accordance with the cultivar or tree age of the grape tree as the detection target from an image.

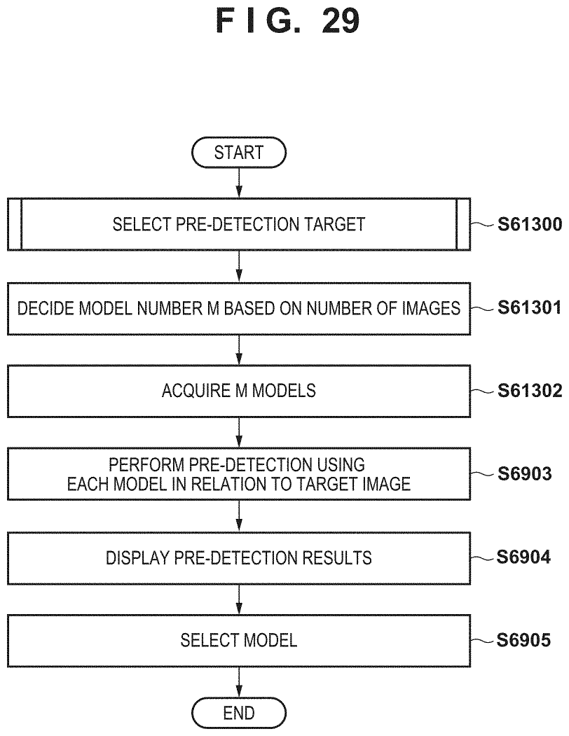

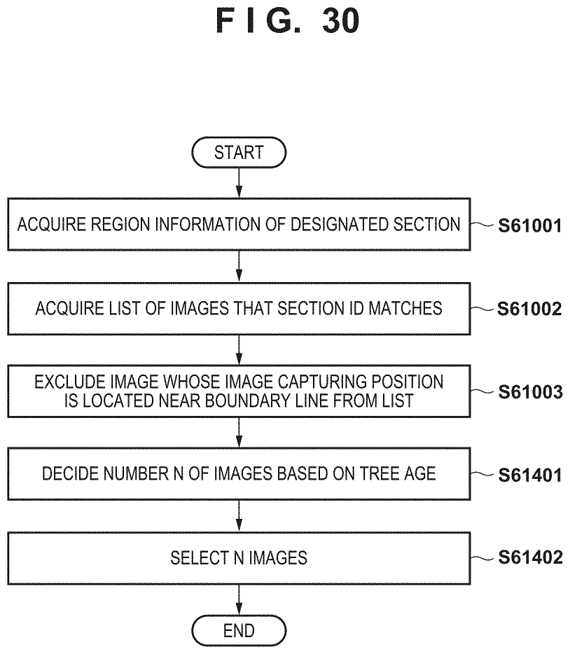

An example of processing of the information processing apparatus according to this embodiment will be described next with reference to FIGS. 29 and 30.

FIG. 29 will be described first. In an example shown in FIG. 29, the same step numbers as in the example shown in FIG. 25 denote the same processes. That is, the example shown in FIG. 29 is different from the example shown in FIG. 25 in the processes of steps S61300, S61301, and S61302. The series of processes shown in FIG. 29 will be described below while placing focus particularly on the portions different from the example shown in FIG. 25.

In step S61300, the detection target selection unit 6404 decides the number of images as the target of pre-detection and selects images as many as the number by processing to be described later with reference to FIG. 30.

In step S61301, the detection unit 6405 decides the number M of models to be used for pre-detection of a predetermined target based on the number of images selected in step S61300.

Note that the method of deciding the number M of models is not particularly limited if it is a decision method based on the selected number of images. As a detailed example, the number M of models may be decided based on whether the number of images is equal to or more than a threshold. As another example, the correspondence relationship between the range of the number of images and the number M of models may be defined as a table, and the number M of models may be decided by referring to the table in accordance with the selected number of images.

Also, control for making the number of models to be used for pre-detection smaller as the number of images becomes larger is preferably applied. When such control is applied, for example, an increase in the processing amount of pre-detection caused by an increase in the number of images can be suppressed. In addition, if the number of images is small, more models are used for pre-detection. For this reason, choices of models increase, and a more preferable model can be selected.

In step S61302, the model management unit 6403 extracts M models from the series of models under management based on the model management table 61201. Also, the detection unit 6405 acquires, from the model management unit 6403, information about each of the extracted M models.

Note that when extracting the models, models to be extracted may be decided by collating the attribute information of a target section with the attribute information of each model. As a detailed example, models with which information similar to at least one of information about the cultivar of the grape tree, which is the attribute information of the target section, and information about the tree age of the grape tree is associated may be extracted preferentially. In addition, when extracting the models, if information about the tree age is used, and there is no model with which information matching the information about the tree age associated with the target section is associated, a model with which a value closer to the tree age is associated may be extracted preferentially.

Note that steps S6903 to S6905 are the same as in the example shown in FIG. 25, and a detailed description thereof will be omitted.

FIG. 30 will be described next. In an example shown in FIG. 30, the same step numbers as in the example shown in FIG. 26 denote the same processes. That is, the example shown in FIG. 30 is different from the example shown in FIG. 26 in the processes of steps S61401 and S61402. The series of processes shown in FIG. 30 will be described below while placing focus particularly on the portions different from the example shown in FIG. 26.

The processes of steps S61001 to S61003 are the same as in the example shown in FIG. 26. That is, the detection target selection unit 6404 acquires a list of images associated with the ID of a designated section, and excludes, from the list, images whose image capturing positions are located near the boundary of the section.

In step S61401, the detection target selection unit 6404 acquires the attribute information of the designated section from the section management table 6601, and decides the number N of images to be used for pre-detection based on the attribute information. As a detailed example, the detection target selection unit 6404 may acquire information about the tree age of the grape tree as the attribute information of the section, and decides the number N of images to be used for pre-detection based on the information.

Note that the method of deciding the number N of images is not particularly limited. As a detailed example, the number N of images may be decided based on whether a value (for example, the tree age of the grape tree or the like) set as the attribute information of the section is equal to or larger than a threshold. As another example, the correspondence relationship between the range of the value set as the attribute information of the section and the number N of images may be defined as a table, and the number N of images may be decided by referring to the table in accordance with the value set as the attribute information of the designated section.

In addition, the condition concerning the decision of the number N of images may be decided in accordance with the type of the attribute information to be used.

For example, if the information about the tree age of the grape tree is used to decide the number N of images, the condition may be set such that the younger a tree is, the larger the number of images to be selected is. When such a condition is set, for example, control can be performed such that the possibility that an image in which a dead branch is captured as a subject is included becomes higher. This is because there is generally a tendency that the older a tree is, the higher the ratio of dead branches is, and the younger a tree is, the lower the ratio of dead branches is.

As another example, if how easily a branch dies changes depending on the cultivar of the grape tree, the number N of images may be decided based on information about the cultivar. If the detection target is a bunch of fruit, information about the amount of bunches estimated at the time of pruning may be set as the attribute information of the section. In this case, the number N of images may be decided based on information about the amount of bunches.

As described above, when information associated with the appearance frequency of the detection target is set as the attribute information of the section, the more preferable number N of images can be decided using the attribute information.

In step S61402, the detection target selection unit 6404 selects N images as the target of pre-detection from the series of images remaining in the list after the images are excluded from the list in step S61003. Note that the method of selecting images from the list in step S61402 is not particularly limited. For example, the detection target selection unit 6404 may select the N images from the list at random.

As described above, the information processing apparatus according to Modification 1 controls the number of images as the target of pre-detection or the number of models to be used based on the attribute information of the section. As a detailed example, the information processing apparatus according to this modification may increase the number N of images to be selected for a young tree with a low ratio of dead branches, as described above. This makes it possible to perform control such that the possibility that an image in which a dead branch is captured as a subject is included in images to be selected as the target of pre-detection becomes higher. Also, the information processing apparatus according to this modification may control such that the larger the number N of images selected as the target of pre-detection is, the smaller the number M of models to be used in the pre-detection is. This can suppress an increase in the processing amount when applying models to images and suppress an increase in time until selection of models to be applied to actual detection is enabled.

(Modification 2)

Modification 2 will be described below. In Modification 1, an example of a mechanism has been described, which is configured to suppress an increase in the processing amount when applying models to images and enable selection of images that are more preferable as the target of pre-detection by controlling the number of images as the target of pre-detection or the number of models to be used based on the attribute information of a section. On the other hand, even if such control is applied, an image in which the detection target is not captured as a subject may be included in the target of pre-detection. As a result, a situation in which the number of images in which the detection target is captured as a subject is smaller than assumed may occur.

In this modification, an example of a mechanism will be described, which is configured to perform control such that if the number of images in which the detection target is detected is smaller than a preset threshold as a result of execution of pre-detection, an image as the target of pre-detection is added, thereby enabling selection of a more preferable model.

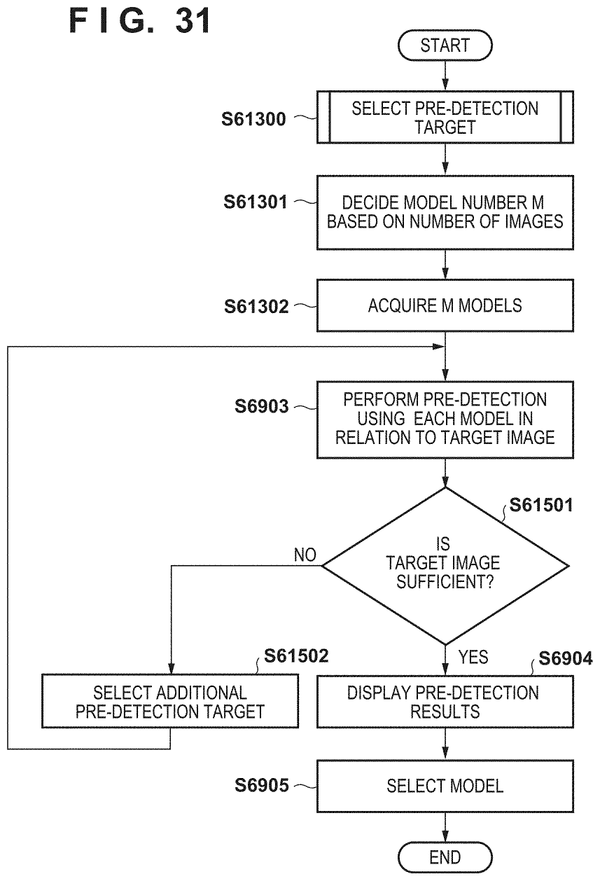

For example, FIG. 31 is a flowchart showing an example of processing of an information processing apparatus according to this modification. In an example shown in FIG. 31, the same step numbers as in the example shown in FIG. 29 denote the same processes. That is, the example shown in FIG. 31 is different from the example shown in FIG. 29 in the processes of steps S61501 and S61502. The series of processes shown in FIG. 31 will be described below while placing focus particularly on the portions different from the example shown in FIG. 29.

The processes of steps S61300 to S61302 and S6903 are the same as in the example shown in FIG. 29. That is, the detection target selection unit 6404 selects N images as the target of pre-detection. Also, the detection unit 6405 selects M models in accordance with the number N of images, and applies the M models to the N images, thereby performing pre-detection of a predetermined target.

In step S61501, the detection unit 6405 determines, based on the result of pre-detection in step S6903, whether the images applied as the target of pre-detection are sufficient. As a detailed example, the detection unit 6405 determines whether the average value of the numbers of detected detection targets (for example, dead branches) per model is equal to or more than a threshold. If the average value is less than the threshold, it may be determined that the images applied as the target of pre-detection are not sufficient. Alternatively, considering a case in which a model (for example, a model whose number of detection errors is larger than that of other models by a threshold or more) that causes an enormous amount of detection errors as compared to other models exists, the detection unit 6405 may determine whether the number of detection targets detected by each model is equal to or more than a threshold. Also, to prevent a situation in which the processing time becomes longer than assumed along with an increase in the processing amount, the detection unit 6405 may decide, in advance, the maximum value of the number of detection targets to be detected using each model. In this case, if the number of detection targets detected using each model reaches the maximum value, the detection unit 6405 may determine that the images applied as the target of pre-detection are sufficient.

Upon determining in step S61501 that the images applied as the target of pre-detection are not sufficient, the detection unit 6405 advances the process to step S61502. In step S61502, the detection target selection unit 6404 additionally selects an image as the target of pre-detection. In this case, in step S6903, the detection unit 6405 newly performs pre-detection for the image added in step S61502. In step S61501, the detection unit 6405 newly determines whether the images applied as the target of pre-detection are sufficient.

Note that the method of additionally selecting an image as the target of pre-detection by the detection target selection unit 6404 in step S61502 is not particularly limited. As a detailed example, the detection target selection unit 6404 may additionally select an image as the target of pre-detection from the list of images acquired by the processing of step S61300 (that is, the series of processes described with reference to FIG. 30).

Upon determining in step S61501 that the images applied as the target of pre-detection are sufficient, the detection unit 6405 advances the process to step S6904. Note that processing from step S6904 is the same as in the example shown in FIG. 29.

As described above, if the number of detected detection targets is less than a preset threshold as the result of executing pre-detection, the information processing apparatus according to Modification 2 adds an image as the target of pre-detection. Hence, an effect of enabling selection of a more preferable model can be expected.

(Modification 3)

Modification 3 will be described below. In the above-described embodiment, a method has been described in which the detection target selection unit 6404 selects an image as the target of pre-detection based on information about the region of a section, which is the attribute information of the section.

In this modification, an example of a mechanism will be described, which is configured to select a variety of images as the target of pre-detection using the attribute information of images and enable selection of more preferable images.

In general, when images to be used to construct a model are selected such that the tint and brightness are diversified, the detection result of the target by the model is also expected to be diversified. Hence, comparison between models tends to be easy. The following description will be made while placing focus on a case in which information about brightness of an image is used as the attribute information of the image. However, the operation of an information processing apparatus according to this modification is not necessarily limited. As a detailed example, as the attribute information of an image, information about a tint may be used, or information about the position where the image was captured or information (for example, a fence number or the like) about a subject as the image capturing target of the image may be used.

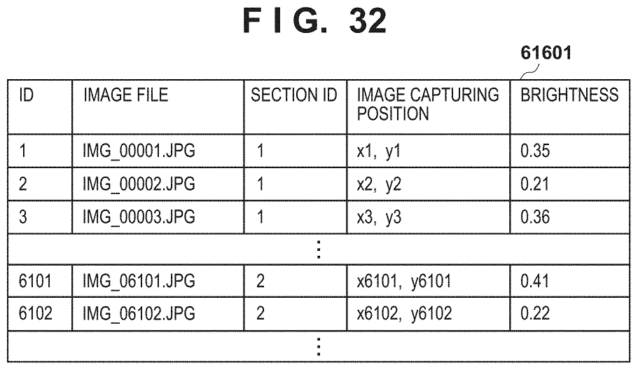

An example of an image management table to be used by the image management unit 6402 according to this modification to manage image data will be described first with reference to FIG. 32. An image management table 61601 shown in FIG. 32 is different from the image management table 6701 shown in FIG. 23 in that information about brightness is included as attribute information. As the information about brightness, for example, a value obtained by averaging, between a series of pixels in an image, the brightness values of the pixels, which are calculated based on a general method using the RGB values of the pixels (that is, the average value of the brightness values of the pixels in the image) can be applied.

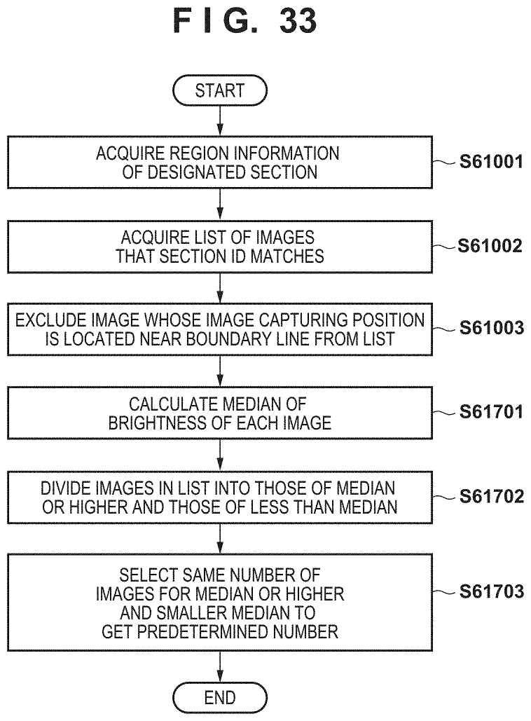

An example of processing of the information processing apparatus according to this modification will be described next with reference to FIG. 33 while placing focus particularly on processing of selecting an image as the target of pre-detection by the detection target selection unit 6404. In an example shown in FIG. 33, the same step numbers as in the example shown in FIG. 26 denote the same processes. That is, the example shown in FIG. 33 is different from the example shown in FIG. 26 in the processes of steps S61701 to S61703. The series of processes shown in FIG. 33 will be described below while placing focus particularly on the portions different from the example shown in FIG. 26.

The processes of steps S61001 to S61003 are the same as in the example shown in FIG. 26. That is, the detection target selection unit 6404 acquires a list of images associated with the ID of a designated section, and excludes, from the list, images whose image capturing positions are located near the boundary of the section.

In step S61701, the detection target selection unit 6404 acquires information about brightness in the attribute information of each image included in the list of images, and calculates the median of the brightness values between the series of images included in the list.

In step S61702, the detection target selection unit 6404 compares the median calculated in step S61701 with the brightness value of each of the series of images included in the list of images, thereby dividing the series of images into images whose brightness values are equal to or larger than the median and images whose brightness values are smaller than the median.

In step S61703, the detection target selection unit 6404 selects images as the target of pre-detection from the list of images such that the number of images whose brightness values are equal to or larger than the median and the number of images whose brightness values are smaller than the median become almost equal, and the sum of the numbers of images becomes a predetermined number. Note that the method of selecting images from the list in step S61703 is not particularly limited. For example, the detection target selection unit 6404 may select images from the list at random such that the above-described conditions are satisfied.

As described above, the information processing apparatus according to Modification 3 selects an image as the target of pre-detection using the attribute information of the image (for example, information about brightness). When such control is applied, the result of pre-detection is diversified, and comparison between models can easily be performed. Hence, a more preferable model can be selected.

Note that in this modification, an example in which the attribute information of an image is acquired from the information of the pixels of the image has been described. However, the method of acquiring the attribute information of an image is not limited. As a detailed example, the attribute information of an image may be acquired from meta data such as Exif information associated with image data when an image capturing device generates image data in accordance with an image capturing result.

### OTHER EMBODIMENTS

Embodiments have been described above, and the present invention can take a form of, for example, a system, an apparatus, a method, a program, or a recording medium (storage medium). More specifically, the present invention is applicable to a system formed from a plurality of devices (for example, a host computer, an interface device, an image capturing device, a web application, and the like), or an apparatus formed from a single device.

In the above-described embodiments and modifications, an example in which the present invention is mainly applied to the agriculture field has mainly been described. However, the application field of the present invention is not necessarily limited. More specifically, the present invention can be applied to a situation in which a target region is divided into a plurality of sections and managed, and a model constructed based on machine learning is applied to an image according to the image capturing result of the section, thereby detecting a predetermined target from the image.

Also, the numerical values, processing timings, processing orders, the main constituent of processing, the configurations/transmission destinations/transmission sources/storage locations of data (information), and the like described above are merely examples used to make a detailed description, and are not intended to be limited to the examples.

In addition, some or all of the above-described embodiments and modifications may appropriately be used in combination. Also, some or all of the above-described embodiments and modifications may selectively be used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-179983, filed Oct. 27, 2020, Japanese Patent Application No. 2021-000560, filed Jan. 5, 2021, and Japanese Patent Application No. 2021-000840, filed Jan. 6, 2021 which are hereby incorporated by reference herein in their entirety.

What is claimed is:

1. An information processing apparatus comprising:
a first selection unit configured to select, as at least one candidate learning model, at least one learning model from a plurality of learning models learned under learning environments different from each other based on information concerning image capturing of an object;
a second selection unit configured to select at least one candidate learning model from the at least one candidate learning model based on a result of object detection processing by the at least one candidate learning model selected by the first selection unit; and
a detection unit configured to perform the object detection processing for a captured image of the object using at least one candidate learning model of the at least one candidate learning model selected by the second selection unit.

2. The apparatus according to claim 1, wherein the first selection unit generates a query parameter based on the information, and selects, as the at least one candidate learning model, at least one learning model learned in an environment similar to an environment indicated by the query parameter from the plurality of learning models.

3. The apparatus according to claim 1, wherein the second selection unit obtains, for each of the at least one candidate learning model selected by the first selection unit, a score based on the result of the object detection processing by the at least one candidate learning model, and selects, based on the scores of the at least one candidate learning model selected by the first selection unit, at least one candidate learning model from the at least one candidate learning model selected by the first selection unit.

4. The apparatus according to claim 1, further comprising a display control unit configured to display the results of the object detection processing by the at least one candidate learning model selected by the second selection unit.

5. The apparatus according to claim 4, wherein the display control unit decides, for each of a plurality of captured images that have undergone the object detection processing by the at least one candidate learning model selected by the second selection unit, a score with a higher value as the difference of the result of the object detection processing between the at least one candidate learning model is larger, and displays, for each of the at least one candidate learning model selected by the second selection unit, a graphical user interface including the results of the object detection processing by the at least one candidate learning model for a predetermined number of captured images from the top in descending order of score.

6. The apparatus according to claim 5, wherein the graphical user interface includes a selection portion used to select a candidate learning model, and
the detection unit sets, as a selected learning model, a candidate learning model corresponding to the selection portion selected in accordance with a user operation on the graphical user interface, and performs the object detection processing using the selected learning model.

7. The apparatus according to claim 5, wherein the detection unit sets, as a selected learning model, a candidate learning model for which the number of results of object detection processing selected in accordance with a user operation is largest from among the results of object detection processing displayed for each candidate learning model by the display control unit, and performs the object detection processing using the selected learning model.

8. The apparatus according to claim 1, further comprising a unit configured to perform prediction of a yield of a crop and detection of a repair part in a farm field based on a detection region of the object obtained as the result of the object detection processing.

9. The apparatus according to claim 1, wherein the information includes Exif information of the captured image, information concerning a farm field in which the captured image is captured, and information concerning the object included in the captured image.

10. The apparatus according to claim 1, further comprising a unit configured to set an apparatus configured to capture and inspect an outer appearance of a product based on a detection region of the object obtained as the result of the object detection processing.

11. The apparatus according to claim 1, wherein the information includes information concerning the object included in the captured image.

12. The apparatus according to claim 1, wherein the detection unit performs the object detection processing for the captured image of the object using a candidate learning model selected based on a user operation from the at least one candidate learning model selected by the second selection unit.

13. An information processing method performed by an information processing apparatus, comprising:
selecting, as at least one candidate learning model, at least one learning model from a plurality of learning models learned under learning environments different from each other based on information concerning image capturing of an object;
selecting at least one candidate learning model from the at least one candidate learning model based on a result of object detection processing by the selected at least one candidate learning model; and
performing the object detection processing for a captured image of the object using at least one candidate learning model of the selected at least one candidate learning model.

14. A non-transitory computer-readable storage medium storing a computer program configured to cause a computer to function as:
a first selection unit configured to select, as at least one candidate learning model, at least one learning model from a plurality of learning models learned under learning environments different from each other based on information concerning image capturing of an object;
a second selection unit configured to select at least one candidate learning model from the at least one candidate learning model based on a result of object detection processing by the at least one candidate learning model selected by the first selection unit; and
a detection unit configured to perform the object detection processing for a captured image of the object using at least one candidate learning model of the at least one candidate learning model selected by the second selection unit.
